(19) United States
(12) Patent Application Publication
(10) Pub. No.: US 2026/0241897 A1
(43) Pub. Date: Aug. 20, 2026

(54) AUTOMATIC TRAILER UNCOUPLING SYSTEM

(71) Applicant: NORCO INDUSTRIES, INC., Compton, CA (US)

(72) Inventors: Jon STOUGH, Angola, IN (US); William ASKE, Cassopolis, MI (US); Nathan STROZIER, Wakarusa, IN (US); Daryl HOCHSTETLER, Goshen, IN (US); Bryan BILLER, Goshen, IN (US)

(21) Appl. No.: 19/539,617

(22) Filed: Feb. 13, 2026

Related U.S. Application Data
(60) Provisional application No. 63/758,616, filed on Feb. 14, 2025.

(51) Int. Cl. B60S 9/08; B60S 9/02; B60S 9/04

(52) U.S. Cl. CPC B60S 9/08; B60S 9/02; B60S 9/04

(57) ABSTRACT

A jack control system for instructing a jack how to raise a trailer relative to a tow vehicle to thereby assist in uncoupling the trailer from the tow vehicle. The jack control system includes a jack and a controller. The jack includes a motor and a leg operatively connected to the motor, wherein the motor is operable to extend or retract the leg. The controller is operatively connected to the motor and is configured to cause extension of the leg based on current drawn by the motor, voltage of the motor, a predetermined period of time, and/or difference in angular orientation of the trailer.

### CROSS-REFERENCE TO RELATED APPLICATIONS

This application claims the benefit of priority from U.S. Provisional Application No. 63/758,616 filed on Feb. 14, 2024, the entirety of which is incorporated herein by reference.

### FIELD OF THE DISCLOSURE

The present disclosure relates generally to trailers and, more particularly, to methods and systems for automatically uncoupling trailers from tow vehicles.

### BACKGROUND OF THE DISCLOSURE

Connecting (or coupling) and disconnecting (or uncoupling) a trailer from a tow vehicle may be a tedious, tiring, and time-consuming procedure. For example, in order to uncouple the trailer from the tow vehicle, the user may need to manually extend a jack to lift the trailer off the of tow vehicle's hitch ball and, as the jack is moving, the user needs to monitor position of the trailer relative to the ball hitch and stop extending the jack once the trailer has cleared the hitch ball of the tow vehicle. Depending on the speed at which the jack extends, this process can be time consuming and difficult, especially if manually extending the jack requires pressing and holding a button during that time. Accordingly, a need exists for a simplified and easier means for uncoupling the trailer from the tow vehicle.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a jack system includes a jack. The jack further includes a motor and a leg operatively connected to the motor. The motor is operable to extend or retract the leg. The jack system further includes a controller operatively connected to the motor. The controller is configured to monitor electrical current draw of the motor as the motor extends the leg and determine a grounded state when electrical current draw exceeds a minimum threshold. Further, upon determination of the grounded state, the controller is configured instruct the motor to continue extending the leg, continue monitoring electrical current draw of the motor as the motor continues to extend the leg, and determine a currently loading state as the electrical current draw increases over time. The controller is also configured to determine a fully loaded state when electrical current draw stabilizes. Additionally, the controller is configured to instruct the motor to continue extending the leg for a predetermined period of time.

According to another embodiment consistent with the present disclosure, a jack system includes a jack. The jack includes a jack, a motor, and a leg operatively connected to the motor. The motor is operable to extend or retract the leg. The jack system further includes a controller operatively connected to the motor. The controller is configured to monitor electrical current draw of the motor and determine a grounded state when electrical current draw exceeds a minimum threshold. Additionally, the controller is configured to instruct the motor to continue extending the leg for a predetermined period of time.

According to yet another embodiment consistent with the present disclosure, a jack system includes a jack, a motor, a leg operatively connected to the motor. The motor is operable to extend or retract the leg. The jack system further includes a level sensor configured to provide readings indicative of angular orientation. The jack system further includes a controller operatively connected to the motor and the level sensor. The controller is configured to record a preliminary angular orientation based on the readings received from the level sensor. Further, the controller is configured to monitor electrical current draw of the motor as the motor extends the leg and determine a grounded state of the leg when electrical current draw exceeds a minimum threshold. Furthermore, upon determination of the grounded state, the controller is configured to instruct the motor to continue extending the leg, continue monitoring electrical current draw of the motor as the motor continues to extend the leg, and determine a currently loading state as the electrical current draw increases over time. Further still, the controller is configured to determine a fully loaded state when the electrical current draw stabilizes over time. The controller is also configured to instruct the motor to continue extending the leg for a predetermined period of time. The controller is further configured to instruct the motor to extend the leg and compare current readings from the level sensor to the preliminary angular orientation. Additionally, the controller is configured to instruct the motor to cease extension of the leg when a difference between the preliminary angular orientation and the current reading from the level sensor equals a target change in angular orientation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 depicts a trailer when coupled to a tow vehicle, according to one or more embodiments of the present disclosure.

FIG. 2 is a perspective view of a jack arranged on the trailer of FIG. 1, wherein the jack may be configured to perform one or more automatic trailer uncoupling or coupling routine, according to one or more embodiments of the present disclosure.

FIG. 3 is a schematic representation of the jack, in accordance with one or more embodiments of the present disclosure.

FIG. 4A depicts an example uncoupling method that at least partially controls the motor using current, according to one or more embodiments.

FIG. 4B is a plot of current over time that graphically depicts aspects of the method of FIG. 4A.

FIG. 5A depicts an example uncoupling method that at least partially controls the motor using voltage, according to one or more embodiments.

FIG. 5B is a plot of voltage over time that graphically depicts aspects of the method of FIG. 5A.

FIG. 6 is a schematic flowchart of an example method of uncoupling a trailer from a tow vehicle that utilizes angular orientation of the trailer, according to one or more embodiments.

FIGS. 7A-7C depict the trailer when in various angular orientations relative to the tow vehicle.

FIG. 8 depicts another example uncoupling method that at least partially controls the motor using angular orientation of the trailer, according to one or more embodiments.

FIGS. 9A-9F an embodiment of the system when utilized with a fifth wheel trailer, according to one or more embodiments.

FIG. 10 depicts a confirmation graphical user interface (GUI).

FIG. 11 depicts a GUI for adjusting the jack of at least FIG. 3.

FIG. 12 depicts an auto level GUI.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a control system for a trailer that performs uncoupling routines/algorithms. When executed by a controller of the control system, the uncoupling routines/algorithms will result in the front end of the trailer being raised upward, relative to the tow vehicle and the rear end of the trailer, such that a clearance is established between a tongue at the front end of the trailer and a ball of the tow vehicle, which thereby permits safe removal/moving of the tow vehicle. The jack control system includes a jack, and the jack includes a motor and a leg that is extendable upon activation of the motor. The uncoupling routines/algorithms may be used to control the motor to thereby extend the leg based on operating characteristics of the motor (e.g., voltage and/or current), based on time, and/or based on changes in the angular orientation of the trailer.

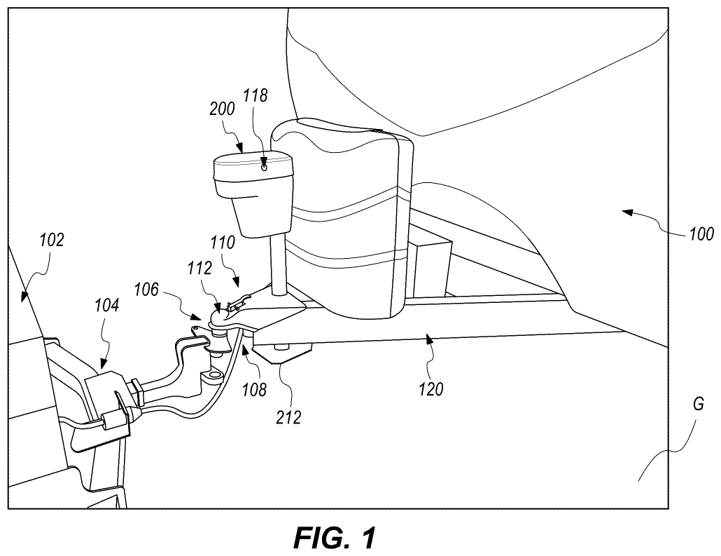

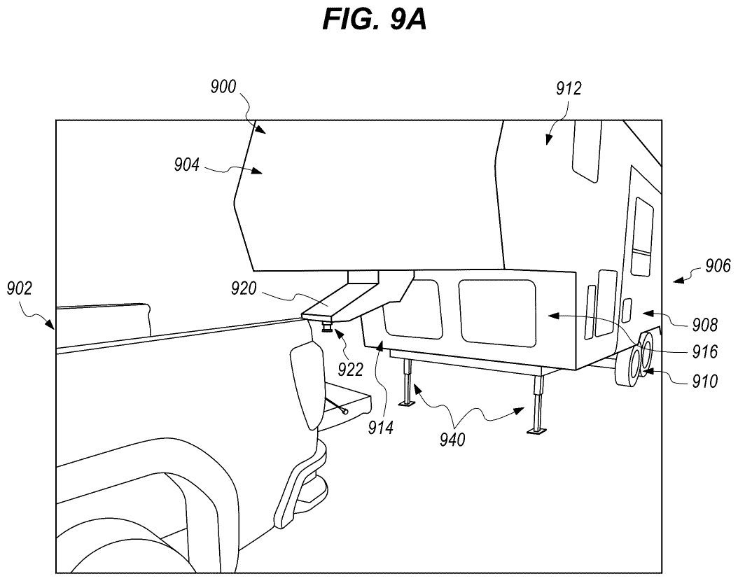

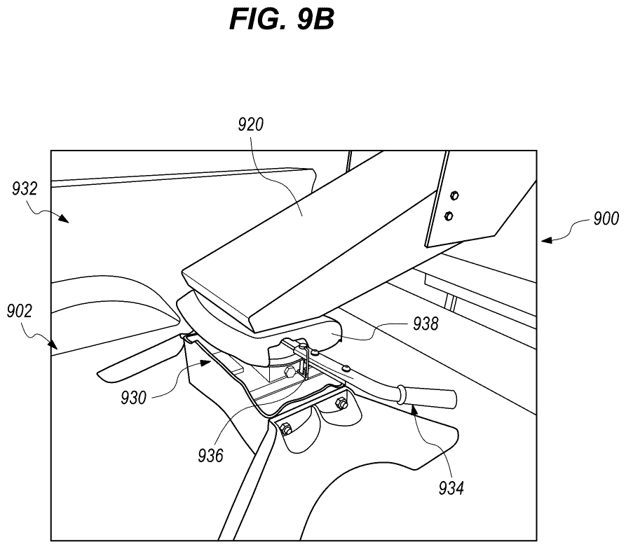

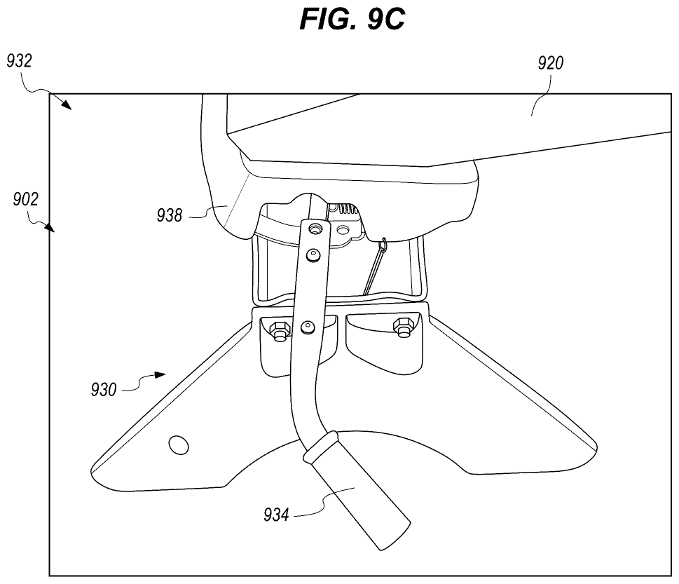

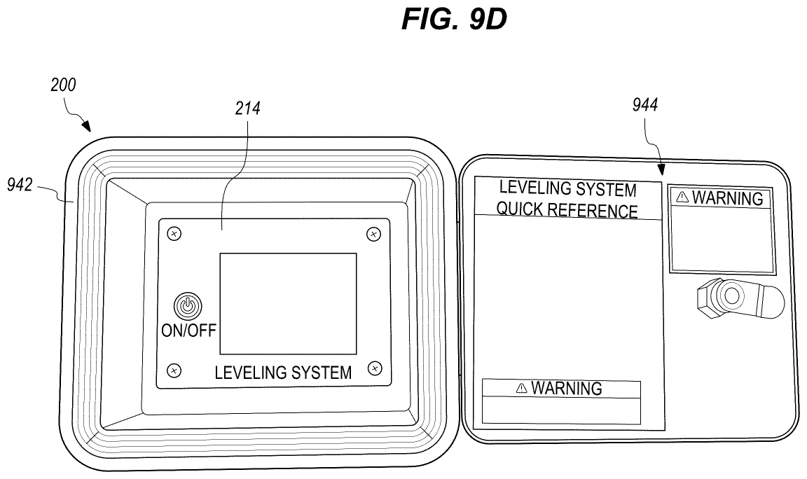

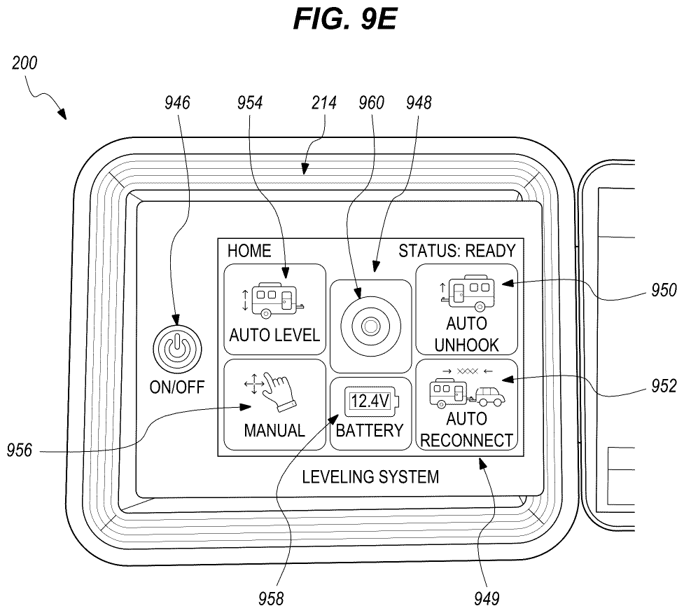

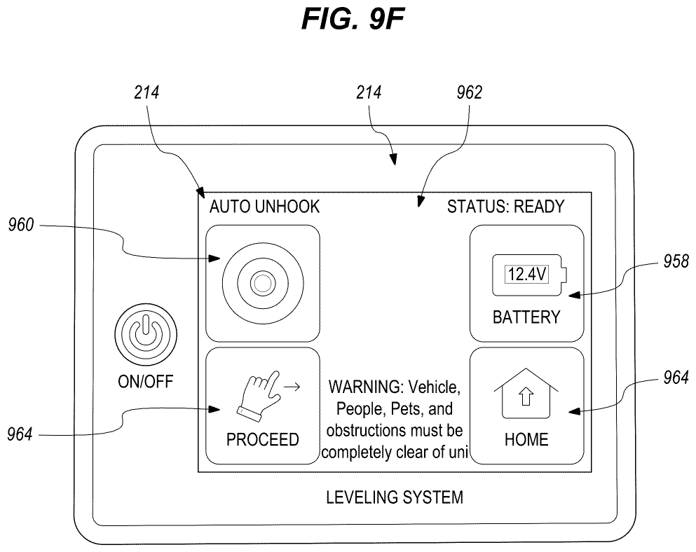

FIG. 1 depicts an example trailer 100 when coupled (i.e., when hitched or attached) to a tow vehicle 102. In the illustrated embodiment, only the rear end of the tow vehicle 102 is depicted; however, it should be appreciated that the tow vehicle 102 may embody various types of vehicles, including but not limited to trucks, vans, cars, SUVs, etc. As shown, the tow vehicle 102 includes a hitch 104 extending from the rear end, and the hitch 104 includes a ball 106. Also in the illustrated embodiment, only a front end 108 of the trailer 100 is depicted; however, it should be appreciated that the trailer 100 also includes a rear end (not shown) that extends rearward away from the front end 108, and that the wheels of the trailer 100 may be provided on the trailer rearward from the front end 108, and that the trailer 100 may embody various types of trailers, including but not limited to recreational trailers, equipment hauling trailers, travel trailers, fifth wheel trailers, etc. Thus, aspects of the present disclosure may be incorporated and used with various types of trailers. In the illustrated embodiment, for example, the trailer 100 is configured as a travel trailer, but it could instead be configured as a fifth wheel trailer which uses motorized landing gear legs to lift the front end 108 the trailer 100 and thereby lift the king pin (or gooseneck) in the upper deck of the fifth wheel trailer off and out of the hitch on the tow vehicle 102 (e.g., in the bed of the truck) as described with reference to FIGS. 9A-9F. Here, the front end 108 of the trailer 100 includes a hitch 110 extending from the front end 108 of the trailer 100, and the hitch 110 of the trailer 100 includes a tongue member 112. As indicated above, the illustrated trailer 100 is a travel trailer, but in embodiments where the trailer 100 is a fifth wheel trailer, the hitch 110 may be provided in the bed of the tow vehicle 102. In such embodiments where the trailer 100 is a fifth wheel trailer, a king pin (or gooseneck) in the upper deck of the fifth wheel trailer would be utilized in lieu of the tongue member 112 for coupling to the hitch in the bed of the tow vehicle 102. The tongue member 112 (hereinafter, the tongue 112) is configured to fit over the ball 106 of the tow vehicle 102, such that the tongue 112 is engaged on and with the ball 106, to thereby couple (i.e., connected, hitch, or attach) the trailer 100 to the tow vehicle 102. FIG. 1 depicts the tongue 112 when arranged on the ball 106, such that the trailer 100 is coupled to the tow vehicle 102. To unhitch the tailer 100 from the tow vehicle 102, the tongue 112 will be uncouple (i.e., disconnected, unhitched, unhooked or detached) from the ball 106, such that the tongue 112 no longer envelopes the ball 106 and the tow vehicle 102 may be moved (i.e., driven) away from and relative to the trailer 100 to thereby move the ball 106 out from underneath the tongue 112.

Thus, uncoupling the tongue 112 from the ball 106 may involve raising the tongue 112 relative to the ball 106 so that the tongue 112 no longer envelopes the ball 106 and the ball 106 may be moved with the tow vehicle 102 without interacting with the tongue 112 of the trailer 100. Similarly, coupling the trailer 100 to the tow vehicle 102 may involve lowering the tongue 112 onto the ball 106.

To assist in raising or lowering the tongue 112 relative to the ball 106, a jack control system 200 may be utilized. The jack control system 200 (hereinafter, the system 200) includes a jack 118 that, in the illustrated embodiment, is arranged at the front end 108 of the trailer 100, proximate to the tongue 112. However, the jack 118 may be arranged elsewhere about the trailer 100 in various positions relative to the tongue 112 where the jack 118 is operable to raise the tongue 112 and/or the front end 108 of the trailer 100. In the illustrated embodiment, the jack 118 is fastened/secured to the trailer 100; however, the jack 118 may be removably provided on the trailer 100. Also in the illustrated embodiment, the trailer 100 includes an A-frame portion or tongue portion 120 at the front end 108 of the trailer 100 with the hitch 110 being provided at an end of the A-frame portion 120, and the jack 118 is attached to the A-frame portion 120 just behind (or rearward from, towards a rear end of the trailer 100) the hitch 110. By positioning the jack 118 at the front end 108 of the trailer 100, the jack 118 is operable to facilitate attaching/coupling the trailer 100 to the tow vehicle 102 and, similarly, to facilitate detaching/uncoupling the trailer 100 from the tow vehicle 102. Furthermore, the jack 118 may be embodied by other types of lifting mechanisms that are operable for lifting the trailer 100 out of and into engagement with the tow vehicle; for example, the trailer 100 may instead be a fifth wheel trailer that utilizes motorized landing gear legs to ground and support the front end 108 of the trailer 100 (instead of the jack 118), and in such embodiments the motorized landing gear legs would operate (extend and retract) and be controlled in a similar manner as described with reference to the jack 118.

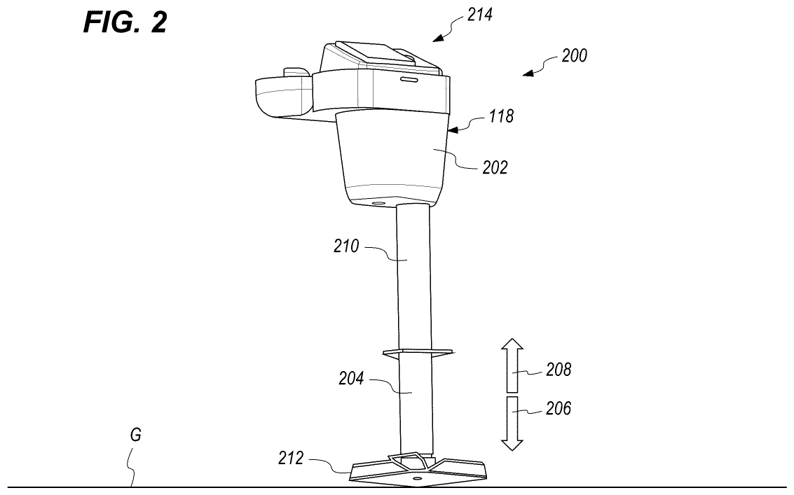

FIG. 2 depicts an example of the jack control system 200 with the jack 118 having been removed from the trailer 100, according to one or more embodiments. In the illustrated embodiment, the jack 118 includes a housing 202 and a leg 204 that is configured to extend or retract, as hereinafter described. The jack 118 also includes a motor, which is obscured from view because, in the illustrated embodiment, the motor is contained inside the housing 202. The motor is operably connected to the leg 204 such that actuation of the motor causes the leg 204 to extend or retract. When the motor extends the leg 204, the leg 204 moves downward toward a ground surface G, as indicated by arrow 206. When the motor retracts the leg 204, the leg 204 moves upward toward the housing 102 and away from the ground surface G, as indicated by arrow 208.

In the illustrated embodiment, the jack 118 includes a sleeve 210 extending downward from the housing 202, and the leg 204 is telescopingly arranged inside the sleeve 210 and operable to slide inside of the sleeve 210 when activated by the motor. Also in the illustrated embodiment, the jack 118 includes a foot pad 212 arranged at a bottom end of the leg 204, wherein the foot pad 212 is configured to make contact with the ground surface G when the leg 204 is sufficiently extended, as hereinafter described. In FIG. 1, the leg 204 is retracted such that it does not contact the ground surface G, whereas FIG. 2 depicts the leg 204 when in close proximity to and contacting the ground surface G.

Also in the illustrated embodiment, the jack control system 200 includes a user interface 214. The user interface 214 is configured to control operation of the motor such that the user interface 114 may cause extension or retraction of the leg 204. The user interface 214 is configured to permit the user/operator to control operation of the motor and thereby control extension/retraction of the leg 204. Thus, the user interface 214 may have one or more buttons that the user may manipulate to cause extension and/or retraction. For example, the user interface 214 may have a first button that causes extension of the leg 204 and a second button that causes retraction of the leg 204. In embodiments, the user interface 214 includes or is (at least partially) configured as a touch screen display that is operable to control the motor. In embodiments where the user interface includes a touch screen display, the buttons utilized to extend and/or retract the leg 204 may be digitally presented buttons that appear on a display of the touch screen display and/or the buttons may be physical buttons that the user/operator has to physically manipulate and press or toggle.

As hereinafter described, the user may utilize the user interface 214 to execute a program (or routine or algorithm) stored in the jack control system 200 that automatically extends and/or retracts the leg 204 to achieve a desired position of the leg 204. For example, when the trailer 100 is coupled to the tow vehicle 102 as shown in FIG. 1, execution of the program/routine stored in the jack control system 200 may cause the motor to extend the leg 204 to contact the ground surface G and then further lift the tongue 112 off of the ball 106 a sufficient distance to create a clearance (between an upper end of the ball 106 and a lower end of the tongue 112 so that the tongue 112 no longer surrounds or envelopes the ball 106) that enables the tow vehicle 102 to be moved/repositioned without pulling the trailer 100 with it. In embodiments, after running any such program/routine, the touch screen display of the user interface 112 may be configured to a display a first button (i.e., a manual extension button that causes extension of the leg 204 when engaged) and/or a second button (i.e., a manual retraction button that causes retraction of the leg 204 when engaged), such that the user may manually extend or retract the leg 204 to allow for further adjustment of the position of the tongue 112 relative to the ball 106, as may be desired, after execution of any stored program/routine/algorithm; and, in embodiments, such manual adjustments may be saved by the user interface 214 and integrated into the stored program/routine/algorithm such that those adjustments are automatically performed by the program/routine/algorithm next time it is run.

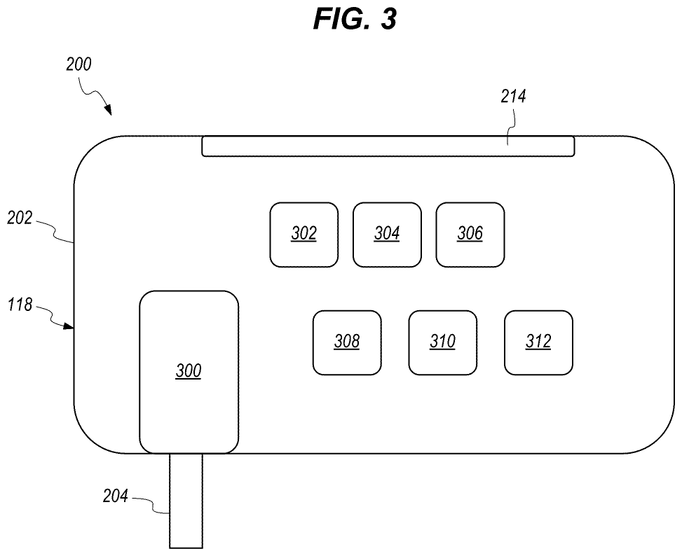

FIG. 3 schematically depicts the jack control system 200, according to one or more embodiments. In particular, FIG. 3 depicts how a motor 300 of the jack 118 may be at least partially arranged within the housing 202. Also, FIG. 3 depicts how the leg 204 is operatively connected to the motor 300, such that the motor 300 is operable to extend or retract the leg 204 (i.e., toward the ground surface G or away from the ground surface G). Further, FIG. 3 depicts how the jack control system 200 includes a controller 302 that is operatively connected/coupled to the motor 300. The controller 302 may be a microcontroller, processor, or similar circuitry for controlling the motors 300.

In the illustrated embodiment, the jack control system 200 also includes a memory 304, at least one sensor 306, clocks or timers 308, one or more processors 310, a power input 312, and/or other components typically utilized with jack systems (e.g., hydraulic, electromechanical) and associated controllers. The controller 302 may house various components operable to control the motor 300, such as an electrical control board, and have various communication ports for wired or wireless communication with other components of the jack control system 200, such as with the motor 300, the memory 304 (e.g., Random Access Memory (RAM) and/or storage), the at least one sensor 306, the clocks or timers 308, the one or more processors 310, the power input 312, and/or with the other components. The power input 312 may include a battery housed within the housing 212 and/or the power input 312 may be connected to an external power source. The external power source may include an external battery or generator, the power source of the trailer 100, and/or the tow vehicle 102, etc.

The ports of the controller 302 may be utilized for coupling external cables to the jack control system 200 for receiving power and/or transmitting data. The controller 302 may be connected to the motor 302 via one or more of the ports, such that various information/data/signals indicative of operation/performance of the motor 300 may be sent to the controller 302 via such one or more ports, thereby allowing the controller 302 to monitor the motor 300. Accordingly, the controller 302 is operable to monitor various operating parameters of the motor 300 such as, for example, current draw and/or voltage. Also, the sensor(s) 306 may also be connected to the controller 302 via the one or more ports, such that the controller 302 is operable to monitor information/data/signals captured via the sensor(s) 306.

In some examples, an external computing system can couple to the internal electronics of the controller 302 via the port to transmit data and/or extend functionality of the internal electronics of the controller 302.

The one or more sensors 306 may be various types of sensors. In some embodiments, the one or more sensors 306 includes a level sensor configured to transmit a level feedback signal to the controller 302, and the controller 302 is further configured to detect and record the level feedback signal. The level feedback signal may be indicative of an orientation of the trailer 100, for example, the degree at which the A-frame 120 of the trailer 100 extends relative to a horizontal plane, such as the ground surface G. As hereinafter described, this data received from the level sensor may be utilize by the controller 302 to uncouple the trailer 100 from the tow vehicle 102. The one or more sensors 306 may be provided at various locations, for example, it may be integrated within the housing 112 (or on the housing 112), on the user interface 212, it may be attached to the housing 112, and/or provided elsewhere about the trailer 100 outside of or unattached to the housing 112. For example, it may be located at a mid-point or centrally located portion of the trailer 100. In some embodiments, the sensor 306 is part of a leveling controller that is in communication with the user interface 212 to transmit level feedback signals (or data indictive of the attitude of the trailer 100) to the user interface 212 such that the user interface 212 may int turn send such signals to the motor 300. However, the level sensor (or the leveling controller when the level sensor is integrated within the leveling controller) may be installed elsewhere about the trailer 100, for example, in a baggage storage area of the trailer 100, in a cabinet inside of the trailer 100, on the frame, etc.

In embodiments, the one or more sensors 306 includes a multi-axis digital sensor operable to provide readings from three or more axes describing an angular orientation of the portion of the structure (e.g., the jack 118 or A-frame 120) on which the sensor 306 is attached. Here, the multi-axis digital sensor provides digital signals to the controller 302 describing an angular orientation of at least the portion of the structure to/on which the sensor 306 is attached, and the controller 302 may be programmed to instruct the motor 300 to extend the leg 204 and thereby move the portion of the structure into a desired attitude by transmitting jack control signals to the motor 300 to thereby extend and retract the leg 204, the control signals based on the digital signals. In embodiments, the multi-axis digital sensor can be one of a 3-axis gyroscope or a 3-axis accelerometer. In embodiments, the multi-axis digital sensor can be a 6-axis digital sensor, and in such embodiments, the 6-axis digital sensor can include a 3-axis gyroscope and 3-axis accelerometer and a processor for interpreting motion data from the gyroscope and accelerometer. Using data from the gyroscope and accelerometer, the attitude (e.g., pitch, roll, or other relative metrics) of the structure can be calculated, and the accelerometer can be used to determine the rate of change of the attitude. Attitude and rate of change can be measured in reference to any point, line, or plane pre-defined or selected while in progress.

The controller 302 can employ adaptive filtering to maximize signal stability based on rate of angular change and estimated signal noise. Through adaptive filtering, controller response to sensor data can be automatically changed depending on at least conditions observed. Adaptive filtering is accomplished by the controller programmed with a software filter algorithm. In embodiments, the filtering can function as and can be similar to a low pass filter. The order of the filter and the pole location is changed depending on operational mode and noise.

As previously mentioned, in embodiments the controller 302 may be a leveling controller and the sensor 306 is a level sensor that is integrated within the leveling controller. In these embodiments, the leveling controller and level sensor may be arranged/installed at locations exterior of the jack 118, for example, on the frame of the trailer 100, in the luggage area of the trailer 100, in a cabinet inside of the trailer, etc. Also in these embodiments, the leveling controller is in communication with the user interface 212 and the motor 300 and is operable to transmit motor control signals directly to the motor 300 or to the user interface 212 that in turn directs such signals to the motor 300. Similarly, in emboidmnets where the system 200 is integrated with a fifth wheel trailer (for example, see FIGS. 9A-9F), the leveling controller may be arranged at various locations inside of the trailer 900 or on the frame thereof, and/or the leveling controller may be integrated into the unit that comprises the user interface 212; and, in such embodiments, the leveling controller may communicate and send leg extension/retraction signals directly to the motor of the motorized landing gear 920, and/or such signals may be transmitted/sent to the user interface 212 which in turn sends them on to the motor of the motorized landing gear 920. Thus, the leveling controller may communicate directly with the motor 300 and/or the leveling controller may communicate with the user interface 212 and the user interface 212 communicates with the motor 300.

The memory 304 may be a hardware memory unit (such as Random Access Memory (RAM)) for storing information during execution of a program/algorithm/routine by jack control system 200 and/or the memory 304 may be a hardware storage unit (such as a hard disk) for retaining/archiving information on a more permanent basis. With regard to the hardware storage unit, such memory 304 may embody an internal hard drive that is in communication with the controller 302 via the ports, and/or such memory 304 may embody a Secure Digital (SD) card that may be inserted into a slot that communicate with a port of the controller 302 and which can be employed to provide firmware or other software capabilities to the electrical components of the jack control system 200. The memory 304 may be contained inside of the jack 118 and/or in the controller 302. In embodiments where the controller 302 is a jack controller with integrated level sensor, the memory 304 may be included in the jack controller; and in such embodiments, the user interface 212 may also include a memory for storing information and/or operating software.

The memory 304 may thus store one or more algorithms/programs/routines that includes instructions for controlling the jack 118. Stated differently, the memory 304 may be programmed with and/or store one or more jack control algorithms/programs/routines. For example, algorithms/programs/routines may be stored in the memory 304 and the controller 302 may be configured to execute the steps/instructions of the algorithms/programs/routines to extend or retract the jack 118 to facilitate coupling or uncoupling of the trailer 100 to or from the tow vehicle 102.

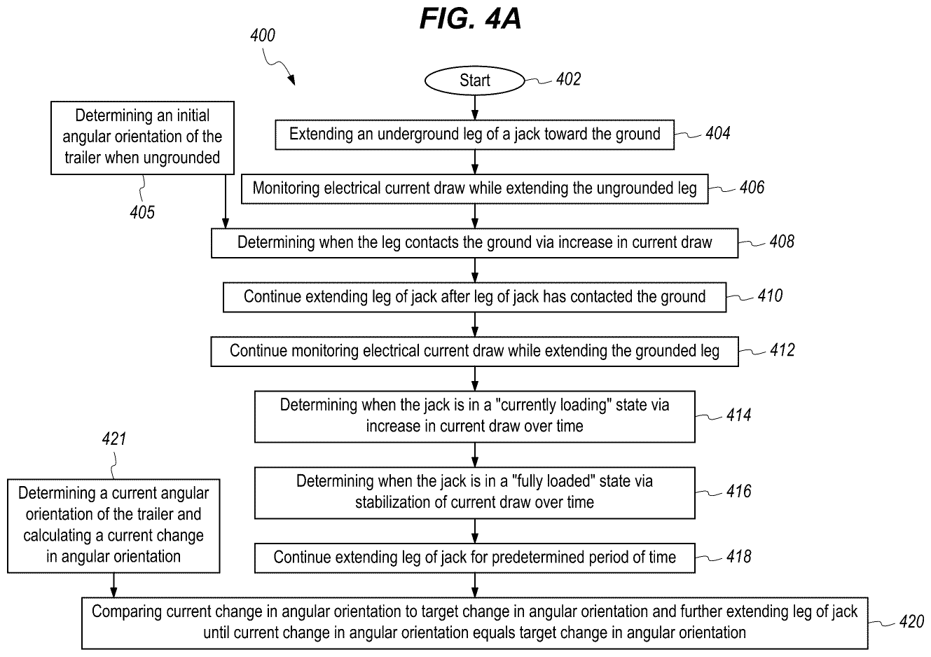

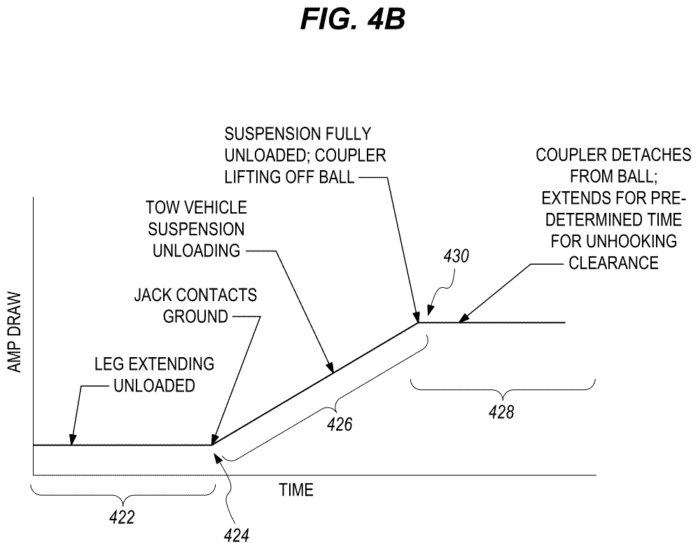

Referring to FIGS. 4-8, example methods illustrating operation of the presently disclosed jack control system 200 are described. The methods may be understood with respect to the features and operations described above with reference to FIGS. 1-3. Thus, for example, the example methods may represent algorithms/sequences/programs stored in the memory 304 and the controller 302 may be configured to perform or execute any of the steps set forth in the example methods detailed herein. While, for purposes of simplicity of explanation, the example methods of FIGS. 4-8 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description. Methods may also be combined in various embodiments.

FIG. 4A depicts a first example uncoupling method 400 for automatically uncoupling the trailer 100 from the tow vehicle 102, according to one or more embodiments. FIG. 4B is a graphical representation of the method 400 of FIG. 4A that graphically depicts current/amp draw of the motor 300 over time. The uncoupling method 400 can be implemented on the jack control system 200. The uncoupling method 400 begins at 402, for example, by using the user interface 214 to start or initiate the automatic uncoupling sequence embodied by the method 400. As mentioned, the user interface 214 may include one or more buttons that the operator may manipulate/press to start/initiate the method 400. At 404, the controller 302 communicates with the jack 118 and instructs the motor 300 to extend the leg 204. Here, the leg 204 is ungrounded, meaning it is not in contact with the ground surface G, such that step 404 involves extending the (ungrounded) leg 204) toward the ground surface G.

At 406, the controller 302 is monitoring electrical current draw of the motor 300 while extending the ungrounded leg 204 (i.e., monitoring current draw while the leg 204 is being extended). At 408, the method 400 includes determining when the leg 204 contacts the ground surface G via an increase in current draw. Here, the controller 204 is configured to determine when the leg 204 contacts the ground surface (i.e., determine a grounded state of the leg 204) by determining that the electrical current draw exceeds a minimum threshold. For example and as shown in FIG. 4B, when the leg 204 is ungrounded (i.e., in an ungrounded state) and being extended towards the ground surface G, current draw of the motor 300 will be at a minimum threshold, as shown by constant current segment 422; however, once the leg 204 contacts the ground surface G, at inflection 424, current draw of the motor 300 will increase beyond/above (i.e., exceed) such minimum threshold as the motor 300 continues to extend the leg 204, as shown with increasing current segment 426. Thus, the controller 302 is configured to monitor electrical current draw of the motor 300 and configured to determine a grounded state of the motor 300 (i.e., when the leg 204 contacts the ground surface G) based on when electrical current draw exceeds a minimum threshold, as indicated at the inflection 424 of the current draw.

At 410, the method 400 includes continue extending the leg 204 after the leg 204 has contacted the ground surface G. Thus, the controller 302 may be configured to instruct the motor 300 to continue extending the leg 204 after determination of the grounded state. At 412 the method 400 includes continue monitoring electrical current draw of the motor 300 while extending the leg 204 and, at 414, the method 400 includes determining when the motor 300 of the jack 118 is in a “currently loading” state via an increase in current draw of the motor 300 over time. Thus, the controller 302 may be configured to continue monitoring electrical current draw of the motor 300 as the motor 300 continues to extend the leg 204, and the controller 302 is configured to determine the “currently loading” state of the motor 300 by sensing and determining electrical current increase of the motor 300 over time, as represented by 426 in FIG. 4B.

Accordingly, after the controller 302 has determined that the leg 204 has contacted the ground surface G (i.e., upon determination of a grounded state of the motor 300), which is shown at inflection 424 in FIG. 4B, the controller 302 is configured to instruct the motor 300 to continue extending the leg 204. Before the leg 204 contacts the ground surface G, the motor 300 is “fully unloaded”, meaning that the load of the trailer 100 is fully supported by the tow vehicle 102 (and the trailer 100 itself), but not by the jack 118; however, once the leg 204 has contacted the ground surface G and as the motor 300 thereafter continues to extend the leg 204 after contacting the ground surface G, the load is at least partially distributed amongst the trailer 100, the tow vehicle 102 and the jack 118, such that the motor 300 is in a “currently loading” state where the jack 118 is taking on and bearing an increasing amount of that load as the motor 300 continues to cause extension of the leg 204. Eventually, the motor 300 will have extended the leg 204 a sufficient distance so as to lift the tongue 112 of the trailer 100 off of the ball 106 of the tow vehicle 102, at which time the jack 118 and will have effectively unloaded the tow vehicle 102 and the motor 300 will be in a “fully loaded” state, meaning the jack 118 is bearing the full load that previously was born by the ball 106 and the tow vehicle 102. In FIG. 4B, the “fully loaded” state is represented by a stabilization of current draw over time, as shown at 428, and the “fully loaded state” begins at inflection 430 where the stabilization of current draw begins.

At 416, the method 400 includes determining when the jack 118 or the motor 330 is in the “fully loaded” state via stabilization of current draw over time. Thus, the controller 302 may be configured to determine the “fully loaded” state based on when electrical current draw of the motor 300 stabilizes, as reflected in FIG. 4B by the inflection 430. However, to ensure that there is ample clearance between the tongue 112 of the trailer 100 and the ball 106 of the tow vehicle 102, to thereby allow the tow vehicle 102 to be driven away from the trailer 100 without interference between the tongue 112 and the ball 106, the method 400 may further include continue extending the leg 204 for a predetermined period/amount of time. Thus, the controller 302 may be configured to instruct the motor 300 to continue extending the leg 204 for a predetermined period of time, after the controller 302 has determined that the motor 300 is in the “fully loaded” state as represented by segment 428 in FIG. 4B. The predetermined amount of time may be various amounts of time that lift the trailer 100 a sufficient distance off of the tow vehicle 102 to allow removal of the ball 106 of the tow vehicle 102 from beneath the tongue 112 of the trailer 100. In embodiments, the predetermined period of time is 5 seconds.

As described above, the jack control system 200 may include the sensor 306, and the sensor 306 may be utilized to help ensure that the trailer 100 has been sufficiently raised (i.e., that the tongue 112 has been sufficiently raised off of the ball 106) to permit withdrawal of the tow vehicle 102. In these embodiments, the sensor 306 may be a level sensor configured to transmit a level feedback signal to the controller 302, wherein the level feedback signal is indicative of the current attitude or orientation of the trailer 100 relative to a horizontal plane, and the controller 302 may be further configured to detect and record the level feedback signal as the current orientation. In these embodiments, a target change/difference in angular orientation may be stored in the control system 200, wherein the target change in angular orientation will be indicative of a change in angular orientation that is known to have positioned the tongue 112 suitably above the ball 106 to permit withdrawal of the tow vehicle 102, and the controller 302 may compare the current change in angular orientation (which is determined by calculating the difference between the current angular orientation measured after the predetermined time period and an initial angular orientation measured when in the ungrounded state) to the target change in angular orientation and, if the current change in angular orientation does not equal (i.e., is lower) than the target change in angular orientation, instruct the motor 300 to further extend the leg 204 until the current change in angular orientation equals the target change angular orientation. For example, the controller 302 may be configured to detect a current level state (i.e., the current orientation of the trailer 100) using the level sensor 306 and instruct the motor 300 to continue extending the leg 204 after the predetermined period of time if, after the predetermined period of time, the controller 302 determines that the current level state is not sufficient via comparison with the target level (i.e., the target orientation of the trailer 100). Thus, at 420, the method 400 may further include comparing current change in angular orientation of the trailer 100 to a target change in angular orientation and further extending the leg until they are equal. Extension of the leg 204 may cease when orientations are equal. In embodiments, the controller 302 may be configured to cease operation of the motor 300 to stop extending the leg 204 during the predetermined time period if the controller 302 determines that the current change in angular orientation equals the target change in angular orientation before the predetermined time period ends. In embodiments that include the step 420, the method 400 may further include a prior step 405 of determining the initial angular orientation of the trailer 100 (e.g., using data from the sensor 306), and this prior step 405 may be performed before the jack system 200 has determined the grounded state; and the method 400 may also include a step 421 of determining a current angular orientation of the trailer 100 and calculating the current change in angular orientation of the trailer 100. In this manner, the initial angular orientation of the trailer 100 may be later utilized, together with the current angular orientations (e.g., which are determined when in the “currently loading” and/or “fully loaded” states via the step 421), to calculate the current change in angular orientation, and then the calculated current change in angular orientation may be compared to the target change in angular orientation to determine whether further extension of the leg 204 is warranted to provide suitable clearance between the tongue 112 and the ball 106.

Alternatively, the user may manually instruct the motor 300 to further extend the leg 204 after the predetermined period of time if, for example, after visual inspection the user determines further extension of the leg 204 is warranted to ensure safe withdrawal of the tow vehicle 102. Such manual instruction of the motor 300 may occur via the user interface 214, which may include a physical button or display a touch screen button for the user to manipulate to extend such leg 204 of the jack 118. For example, the user interface 214 may display a manual extension button and/or a manual retraction button after the predetermined period of time, or such manual extension button and/or manual retraction button may be constantly displayed on the user interface 214. In embodiments, where the user manually the leg 204 to orient the trailer into the desired angular orientation, the controller 302 may be configured to present the option to the user to save/record that final angular orientation of the trailer 100 as a desired angular orientation, such that the target change in angular orientation may be trained into the control system 200 by subtracting that final/desired angular orientation from an initial angular orientation of the trailer 100 that was recorded by the controller 302 when in the ungrounded state, as detailed herein. In this manner, manual adjustments of the jack 118 may be utilized to help train the control system 200 for performing future uncoupling routines, such that the control system 200 automatically learns how to modify its uncoupling routine to ensure suitable clearance, for example, by automatically updating the predetermined amount of time and/or adjusting the target difference in angular orientation to be achieved via the user's manual adjustments that are monitored by the control system 200, which in turn will make the algorithm progressively better during future uses.

While FIG. 4A depicts the method 400 as having several steps, such as steps 404 to 420, the controller 302 may be configured to implement all or less than all of those steps. For example, the controller 302 may be configured to monitor electrical current draw of the motor 300 and determine the grounded state when electrical current draw exceeds the minimum threshold and instruct the motor 300 to continue extending the leg 204 for the predetermined period of time.

Alternatively, the controller 302 may be configured to simply instruct the motor 300 to extend the leg 204 for the predetermined period of time. Here, for example, the jack system 200 may first be utilized in an uncoupling sequence to extend the leg 204 so as to suitably lift the tongue 112 off of the ball 106 to allow withdrawal of the tow vehicle, as discussed elsewhere herein, and during such first uncoupling sequence of raising the tongue 112 off of the ball 106, the controller may measure the length of time that the motor 300 is extending the leg 204 and save/record such amount of time as the predetermined period of time. In this manner, when the control system 200 is subsequently utilized in a second or subsequent uncoupling sequence, the instruct the motor 300 to extend the leg 204 for the predetermined period of time, wherein the predetermined period of time is based on the first/prior uncoupling sequence. Thus, the controller 302 may be configured to measure an amount of time that the motor 300 extends the leg 204 during a first uncoupling sequence, save or record the amount of time as a predetermined period of time, and then, during a second uncoupling sequence, instruct the motor 300 to extend the leg 204 for the predetermined period of time. In embodiments, the user interface 212 will display an option to the user asking them if they'd like to save/record the amount of time that the motor 300 extends the leg 204 as the predetermined period of time. Also, in embodiments, the control system 200 may store various different predetermined period of times, such as those which have been previously saved by the user or pre-programmed at the factory, and prior to running/utilizing any uncoupling sequence on the control system 200, the user may select which predetermined period of time they wish to use in the uncoupling sequence. In this manner, if the trailer 100 is used with several different tow vehicles, the user may select the predetermined period of time that corresponds with the particular tow vehicle 102.

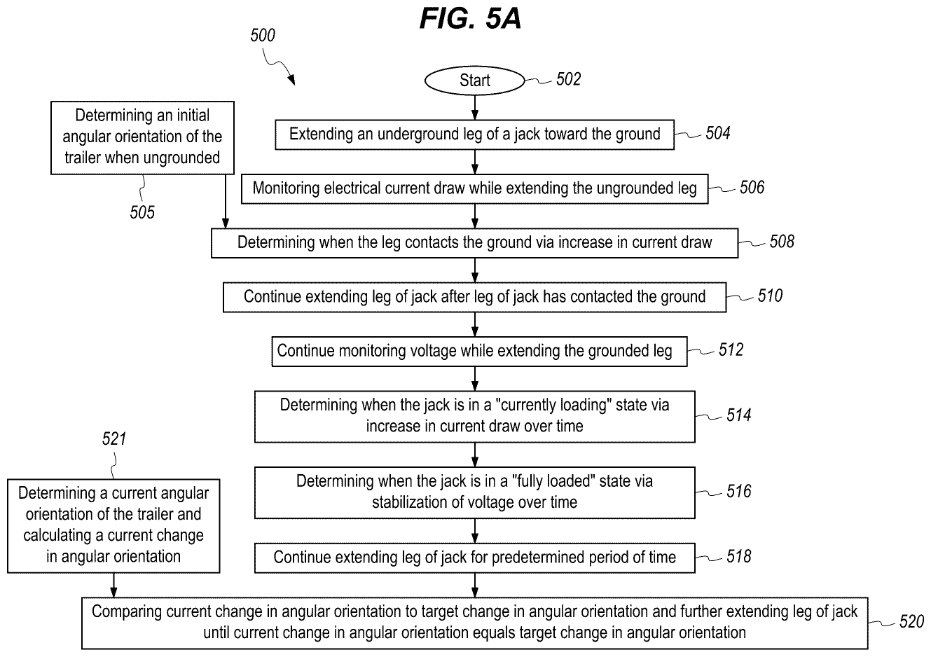

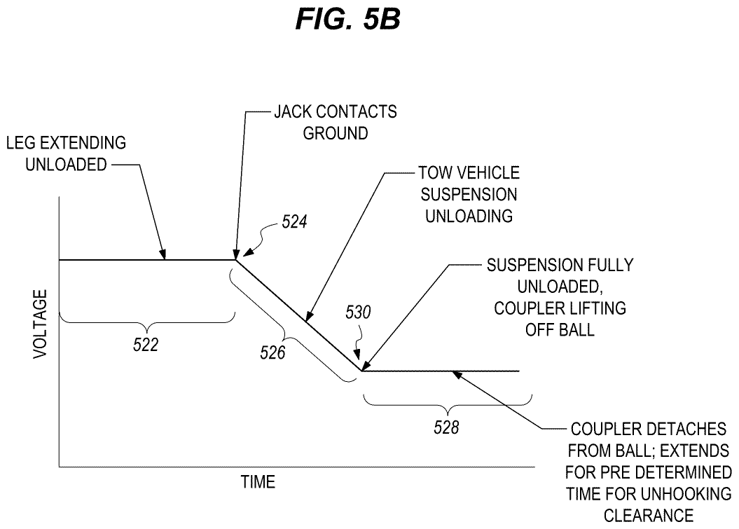

In the method 400 and uncoupling sequence/algorithm described with reference to FIGS. 4A-4B, current draw of the motor 300 is utilized. In particular, as detailed above, current draw of the motor 300 is monitored and analyzed to determine when the jack 118 contacts the ground (i.e., when the motor 300 and/or the leg 204 is in the grounded state), when the jack 118 is in the currently loading state (i.e., when it as it is taking on more and more of the load from the tow vehicle 102 and thus unloading the tow vehicle 102), and when the jack 118 is in the fully loaded state (i.e., where it has fully unloaded the tow vehicle 102 and taking on the load previously supported/born by the tow vehicle 102). In other examples, however, the controller 302 may be configured to monitor voltage of the motor 300, in addition to or in lieu of the current as detailed above, and (at least partially) utilize voltage to determine when and for how long to extend the leg 204. For example, FIG. 5A depicts another example uncoupling method 500 for automatically uncoupling the trailer 100 from the tow vehicle 102, according to one or more embodiments. FIG. 5B is a graphical representation of the method 500 of FIG. 5A that graphically depicts voltage of the motor 300 over time. The uncoupling method 500 can be implemented on the jack control system 200. The uncoupling method 500 begins at 502, for example, by using the user interface 214 to start or initiate the automatic uncoupling sequence embodied by the method 500 when the control system 200 is “ungrounded”, meaning the leg 204 is not in contact with the ground surface G. At 504, the controller 302 communicates with the jack 118 and instructs the motor 300 to extend the leg 204. At 506, the controller 302 is monitoring voltage of the motor 300 while extending the ungrounded leg 204 (i.e., monitoring voltage while the leg 204 is being extended). At 508, the method 500 includes determining when the leg 204 contacts the ground surface G via a decrease in voltage. Here, the controller 204 is configured to determine when the leg 204 contacts the ground surface (i.e., determine a grounded state of the leg 204) by determining that the voltage is less than a maximum threshold. For example and as shown in FIG. 5B, when the leg 204 is ungrounded (i.e., in an ungrounded state) and being extended towards the ground surface G, voltage of the motor 300 will be at a maximum threshold, as shown by constant voltage segment 522; however, once the leg 204 contacts the ground surface G, at inflection 524, voltage of the motor 300 will decrease (depart below) such maximum threshold as the motor 300 continues to extend the leg 204, as shown with decreasing voltage segment 526. Thus, the controller 302 is configured to monitor voltage of the motor 300 and configured to determine a grounded state of the motor 300 (i.e., when the leg 204 contacts the ground surface G) based on when voltage deviates (or falls) below a maximum threshold, the start of which being indicated at the inflection 524 of the voltage plot followed by decreasing voltage segment 526. At 510, the method 500 includes continue extending the leg 204 after the leg 204 has contacted the ground surface G, such that the controller 302 instructs the motor 300 to continue extending the leg 204 after determination of the grounded state. At 512 the method 500 includes continue monitoring voltage of the motor 300 while extending the leg 204 and, at 514, the method 500 includes determining when the motor 300 of the jack 118 is in a “currently loading” state via a decrease in voltage of the motor 300 over time. Thus, the controller 302 may be configured to continue monitoring voltage of the motor 300 as the motor 300 continues to extend the leg 204, and the controller 302 is configured to determine the “currently loading” state of the motor 300 by sensing and determining voltage decrease of the motor 300 over time, as represented by the decreasing voltage segment 526 in FIG. 5B. At 516, the method 500 includes determining when the jack 118 or the motor 330 is in the “fully loaded” state via stabilization of voltage over time. Thus, the controller 302 may be configured to determine the “fully loaded” state based on when voltage of the motor 300 stabilizes, as shown at the inflection 530 and subsequent segment of constant voltage 528 in the plot of FIG. 5B. However, to ensure that there is ample clearance between the tongue 112 of the trailer 100 and the ball 106 of the tow vehicle 102, to thereby allow the tow vehicle 102 to be driven away from the trailer 100 without interference between the tongue 112 and the ball 106, the method 500 may further include continue extending the leg 204 for a predetermined period/amount of time. Thus, the controller 302 may be configured to instruct the motor 300 to continue extending the leg 204 for a predetermined period of time, after the controller 302 has determined that the motor 300 is in the “fully loaded” state as represented by segment 528 in FIG. 5B. The predetermined amount of time may be various amounts of time that lift the trailer 100 a sufficient distance off of the tow vehicle 102 to allow removal of the ball 106 of the tow vehicle 102 from beneath the tongue 112 of the trailer 100, for example, 5 seconds.

As with the method 400 detailed above, the method 500 may utilize sensor data to help orient the trailer 100 so that suitable clearance is created between the tongue 112 and the ball 106. For example, at 520, the method 500 may further include comparing a current change in angular orientation of the trailer 100 to a target change in angular orientation and further extending the leg until they are equal. Extension of the leg 204 may cease when orientations are equal. In embodiments, the controller 302 may be configured to cease operation of the motor 300 to stop extending the leg 204 during the predetermined time period if the controller 302 determines that the current change in angular orientation equals the target change in angular orientation before the predetermined time period ends. In embodiments that include the step 520, the method 400 may further include a prior step 505 of determining the initial angular orientation of the trailer 100 (e.g., using data from the sensor 306), and this prior step 505 may be performed before the jack system 200 has determined the grounded state; and the method 500 may also include a step 521 of determining a current angular orientation of the trailer 100 and calculating the current change in angular orientation of the trailer 100. In this manner, the initial angular orientation of the trailer 100 may be later utilized, together with the current angular orientations (e.g., which are determined when in the “currently loading” and/or “fully loaded” states via step 521), to calculate the current change in angular orientation, and then the calculated current change in angular orientation may be compared to the target change in angular orientation to determine whether further extension of the leg 204 is warranted to provide suitable clearance between the tongue 112 and the ball 106.

Accordingly, in some embodiments, the controller 302 may be configured to monitor voltage of the motor 300 and determine the grounded state when voltage decreases from a maximum threshold; upon determination of the grounded state, instruct the motor 300 to continue extending the leg 204, continue monitoring voltage of the motor 300 as the motor 300 continues to extend the leg 204, and determine a currently loading state as voltage decreases over time; determine a fully loaded state when voltage stabilizes over time; and instruct the motor 300 to continue extending the leg for a predetermined period of time.

While FIG. 5A depicts the method 400 as having several steps, such as steps 504 to 520, the controller 302 may be configured to implement all or less than all of those steps. For example, the controller 302 may be configured to monitor voltage of the motor 300 and determine the grounded state when voltage falls below the maximum threshold and instruct the motor 300 to continue extending the leg 204 for the predetermined period of time.

In embodiments, the controller 302 may be configured to monitor a characteristic of the motor 300 when executing the uncoupling sequence. For example, the controller 302 may be configured monitor a characteristic of the motor and determine a grounded state when the characteristic deviates from a minimum or maximum threshold; upon determination of the grounded state, instruct the motor to continue extending the leg, continue monitoring the characteristic as the motor continues to extend the leg, and determine a currently loading state as the characteristic increases or decreases over time; determine a fully loaded state when the characteristic stabilizes over time; and instruct the motor to continue extending the leg for a predetermined period of time. In embodiments, the characteristic of the motor 302 is current draw of the motor 302 and/or voltage of the motor 302.

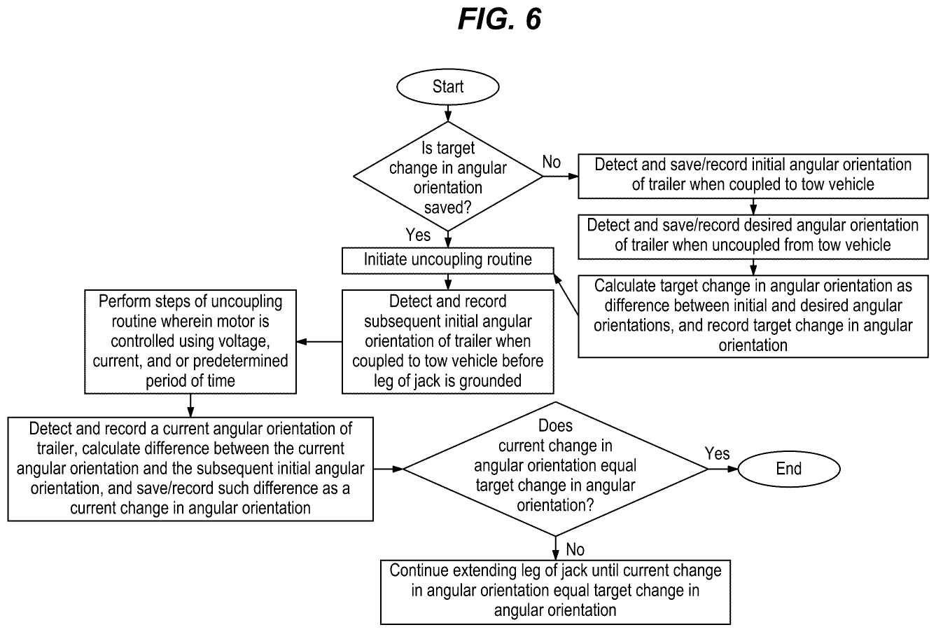

FIG. 6 is a flow chart illustrating how the controller 302 may be configured to utilize data from the sensor 306 to assist in performing the uncoupling sequence, such as the sequences described with reference to FIGS. 4-5, according to one or more embodiments. As described above, the jack control system 200 may include the sensor 306, and the sensor 306 may be utilized to help ensure that the trailer 100 is been sufficiently raised (i.e., that the tongue 112 has been sufficiently raised off of the ball 106) to permit withdrawal of the tow vehicle 102. In these embodiments, the sensor 306 may be a level sensor configured to transmit a level feedback signal to the controller 302, wherein the level feedback signal is indicative of the attitude or orientation of the trailer 100 relative to a horizontal plane, and the controller 306 may be further configured to detect and record the level feedback signal of the trailer 100 when coupled to the tow vehicle 102 and when the jack 118 has unloaded the tow vehicle 102 and compare those angular orientations to calculate a current difference/change in angular orientation that may be compared to a target change in angular orientation to determine whether further extension of the jack 118 is warranted to safely lift the front end of the trailer 100 off of the tow vehicle 102. Here, the controller 302 may be configured to automatically detect and record the level feedback signal as the initial orientation before extending the leg 204 and/or when ungrounded, and to record the level feedback signal as the current angular orientation after the predetermined period of time and/or after sequence has finished controlling the motor 300 using voltage/current/time. The target change in angular orientation may be stored in the control system 200 or may be trained. For example, training the control system 200 may include the user interfacing with the user interface 212 to set and save an initial angular orientation of the trailer 100 when coupled to the tow vehicle and when the jack 118 is ungrounded, then user may then manually extend the leg 204 until the jack 118 is grounded and has fully unloaded the tow vehicle 102 such that sufficient clearance has been created between the tongue 112 and the ball 106 to permit safely withdrawing the tow vehicle 102 from the trailer 100, and then the user may interface with the user interface 212 to set and save that final angular orientation of the trailer 100 as a desired orientation, and the controller 302 may automatically calculate and store a target change in angular orientation as the difference between the initial angular orientation and the desired orientation. The control system 200 may then use the saved/recorded target change in angular orientation during subsequent uncoupling routines. In this manner, manual adjustments of the jack 118 may be utilized to help train the control system 200 for performing future uncoupling routines.

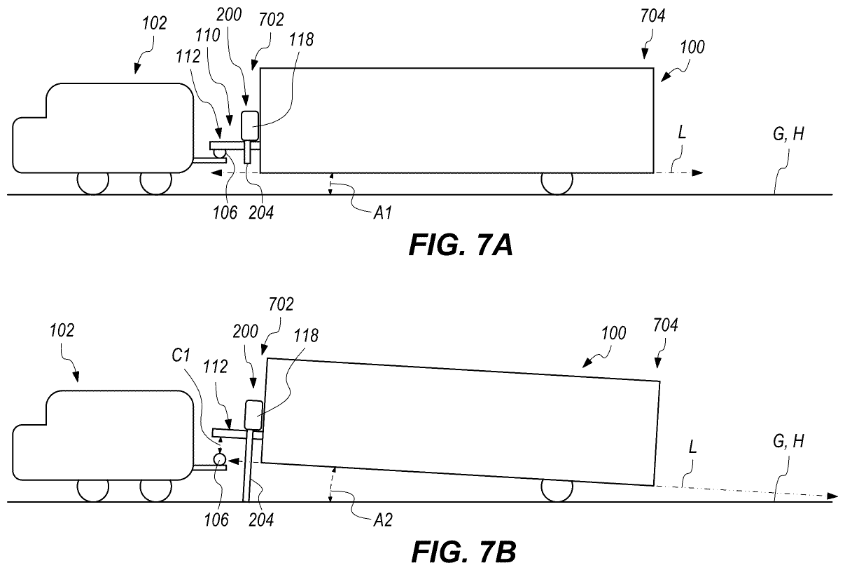

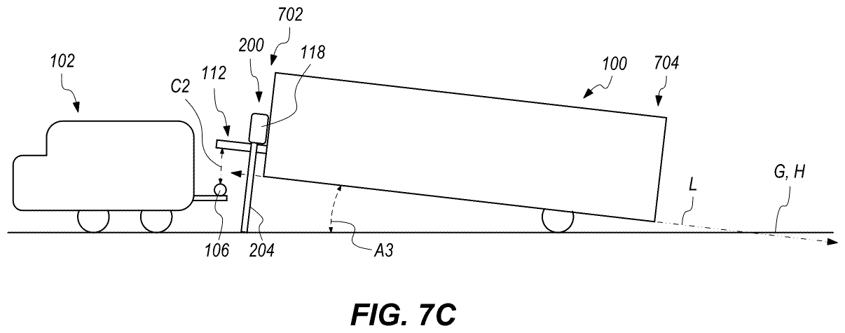

Thus, the control system 200 may be configured to detect/monitor angular orientation of the trailer 100 using the sensor 306 and utilize such sensor data when performing uncoupling routines. For ease of explanation, FIGS. 7A-7C depict the trailer 100 and the tow vehicle 102 when coupled together and when uncoupled, and they also exemplify the different angular orientations in which the trailer 100 may be oriented when coupled and uncoupled from the tow vehicle 102. FIG. 7A depicts orientation of the trailer 100 relative to the tow vehicle 102 when attached/hitched/coupled and FIGS. 7B-7C depict orientation of the trailer 100 relative to the tow vehicle 102 when detached/unhitched/uncoupled, according to embodiments. The trailer 100 extends along (and includes) a longitudinal axis L and includes a front end 702 and a rear end 704, with the hitch 110 arranged at and extending from a body of the trailer 100 at the front end 702. As shown in FIGS. 7A-7C, the orientation/attitude of the trailer 100 is represented as an angle that is measured/defined between the longitudinal axis L and the horizontal plane H. In the depicted embodiments, the horizontal plane H is parallel with and depicted as being co-planar with the ground surface G; however, the trailer 100 may sometimes be situated on a ground surface G that is not parallel or coplanar with the horizontal plane H, for example, when on a sloped surface.

In FIG. 7A, the trailer 100 is in a first angular orientation A1 which is measured between the longitudinal axis L and the horizontal plane H. While FIG. 7A depicts the trailer 100 when attached/hitched/coupled to the tow vehicle 102, FIGS. 7B-7C depict the trailer 100 after the jack 118 has at least partially extended the leg 204 to thereby raise the front end 702 of the trailer 100 relative to the tow vehicle 102 (and relative to the rear end 704 of the trailer), thereby respectively orienting the trailer 100 in a second angular orientation A2 (FIG. 7B) and a third angular orientation A3 (FIG. 7C), each of which in turn creates a clearance between the tongue 112 and the ball 102, with clearance C1 being generated by the angular orientation A2 in FIG. 7B and clearance C2 being generated by the angular orientation A3 of FIG. 7C. The clearance C1 depicted in FIG. 7B may represent a suitable enough clearance between the tongue 112 and the ball 102 to permit safely moving the tow vehicle 102 away from the trailer 100; however, the clearance C1 may also represent a clearance between the tongue 112 and the ball 102 that is not suitable (or desirable) for safely removing the tow vehicle 102 from underneath the trailer 100, such that the jack 118 will need to be further activated to further extend the leg 204 and raise the front end 702 of the trailer, and thereby further increase the clearance C1 into a target (or desired) clearance C2, as shown in FIG. 7C, where it is known that the tow vehicle 102 may be safely moved away from the trailer 100.

As mentioned above, the control system 200 may also perform uncoupling routines/algorithms that utilize angular orientation/attitude of the trailer 100 in addition to the motor characteristics (e.g., current and/or voltage) and/or time periods detailed above. In embodiments, such uncoupling routines/algorithms may include a first part that is uses motor characteristics (e.g., current and/or voltage) and/or time as detailed above and a second part that uses angular orientation/attitude of the trailer 100, wherein the second part may be utilized as a “check” to ensure that the front end 702 of the trailer 100 has been suitably raised to provide a safe enough amount of clearance for removing the tow vehicle 102. In such embodiments, FIG. 7A may depict orientation of the trailer 100 before the controller 302 executes the uncoupling algorithm, FIG. 7B may depict orientation of the trailer 100 after the controller 302 has executed the first part of the uncoupling algorithm (which utilizes the motor characteristics (e.g., current and/or voltage) and/or time periods), and FIG. 7C may depict orientation of the trailer 100 after the controller 302 has executed the second part of the uncoupling algorithm (which utilizes angular orientation and sensor data). Stated differently, FIG. 7B depicts the clearance C1 generated after execution of the first part of the uncoupling algorithm/routine and FIG. 7C depicts clearance C2 generated after execution of the second part of the uncoupling algorithm/routine. Here, the angular orientation A1 of the trailer 100 when coupled to the tow vehicle 102 has been saved/recorded, the clearance C2 (FIG. 7C) is suitable and safe amount of clearance for removing the tow vehicle 102, and the angular orientation A3 which achieves such safe clearance C2 has already been recorded or saved in the control system 200 as a desired or target orientation, such that the control system 200 has calculated a difference between angular orientations A1 and A3 and saved/recorded that difference as the target change in angular orientation. For example, during a prior use of the control system 200, the user may have recorded/saved the initial angular orientation A1 when coupled, and then moved the trailer 100 into the angular orientation A2 and determined that the clearance C2 obtained thereby was safe, such that they saved/recorded the angular orientation A2 in the control system 200, such that the control system 200 previously calculated and stored the target change in angular orientation for later/subsequent use of the control system 200. Alternatively, the target change in angular orientation may be saved in the control system 200 at the factory as a default target/desired orientation to be achieved. Then, when the user subsequently uses the control system 200 to perform an uncoupling routine/algorithm, the controller 302 will measure/detect a current initial angular orientation (e.g., A1) of the trailer 100 when coupled to the tow vehicle 102 and then, after the controller 302 has caused the jack 118 to raise the front end 702 of the trailer 100 using motor characteristics (e.g., current and/or voltage) or time as discussed above, the controller 302 may measure the current angular orientation of the trailer 100 using the sensor 306, calculate and record the current change in angular orientation (i.e., the difference between the current initial angular orientation and current angular orientation), and then compare the current change in angular orientation to the desired or target change in angular orientation. If the controller 302 determines that a difference exists between the current change in angular orientation and the desired/target change in angular orientation, the controller 302 may instruct the motor 300 to further extend the leg 204 until the current change in angular orientation equals desired or target change in angular orientation. Thus, for example, if the trailer 100 is in the angular orientation A3 and has the target clearance C2 shown in FIG. 7C after performing the first part of the uncoupling routine/algorithm, the controller 302 may compare the current angular orientation to the target/desired angular orientation and instruct the instruct the motor 300 to cease extension of the leg 204 and/or end the uncoupling routine/algorithm because there is no difference between the current and desired/target changes in orientations. However, if after performing the first part of the uncoupling routine, the trailer 100 is in the angular orientation A2 and has the lesser clearance C1 shown in FIG. 7B, the controller 302 may instruct the motor 300 to continue extending the leg 204 until the trailer 100 is oriented in angular orientation A3, where the current change in angular orientation equals the target/desired change in angular orientation.

In this example, the controller 302 uses motor characteristics (e.g., current and/or voltage) and/or time periods in addition to a change in angular orientation of the trailer 100 to ensure suitable clearance is established between the tongue 112 and the ball 106. In these embodiments, the control system 200 may be trained to extend the leg 204 of the jack 118 to achieve a target change in angular orientation. The target change in angular orientation may be measured in degrees and may be various values, such as 0.5 degrees. To train the control system 200, for example, the orientation of the trailer 100 when in angular orientation A1 and coupled to the trailer 100, as shown in FIG. 7A, may be recorded/saved as a first angular orientation, and then the trailer 100 may be moved into angular orientation A2 in FIG. 7B after execution of the first part of the uncoupling routine/algorithm (which uses motor characteristics (e.g., current and/or voltage) and/or time periods). The user may then manually activate the motor 300 to extend the leg 204 until the trailer 100 is oriented in the desired/target angular orientation A3 (FIG. 7C), which provides the desired/targeted clearance C2 for safely moving the tow vehicle 102 away from the trailer 100. The user may cause the controller 302 to save this angular orientation A3 as a desired/target angular orientation, and then the controller 302 calculates a difference between the desired/target angular orientation A3 and the first angular orientation A2, and saves the difference as a target change D in angular orientation that may be utilized during subsequent uncoupling operations. After training the control system 200 to acquire the target change D in angular orientation, the control system 200 may be utilized again to automatically orient the trailer 100 into a suitable orientation for uncoupling from the tow vehicle 102. During such subsequent use, for example, the controller 302 may determine an initial angular orientation of the trailer 100 when coupled to the tow vehicle 102, which may be the angular orientation A1 shown in FIG. 7A, and then the controller may execute the first part of the uncoupling routine/algorithm, which in turn may result in positioning the trailer 100 in an orientation such as the angular orientation A2 shown in FIG. 7B. The controller 302 may record this angular orientation A2 as a current angular orientation, calculate the current difference between this current angular orientation A2 and the initial angular orientation A1, and compare that difference to the target change D in angular orientation (that was previously trained into the control system 200) to determine if they are equal. If, upon comparing the target change D in angular orientation to the current difference in angular orientation, the controller determines that they are not equal, the controller 302 will instruct the motor 300 to extend the leg 204. While extending the leg 204, the controller 302 may continuously monitor the current orientation of the trailer 102, calculate a current difference/change between the current orientation of the trailer 100 and the initial orientation of the trailer 100, and compare the current difference/change to the target change D in angular orientation. The controller 302 may instruct the motor 300 to cease extension of the leg 204 when the current difference/change equals the target change D in angular orientation. Stated differently, the controller 302 may instruct the motor 300 to continue extending the leg 204 until the current difference/change equals the target change D in angular orientation.

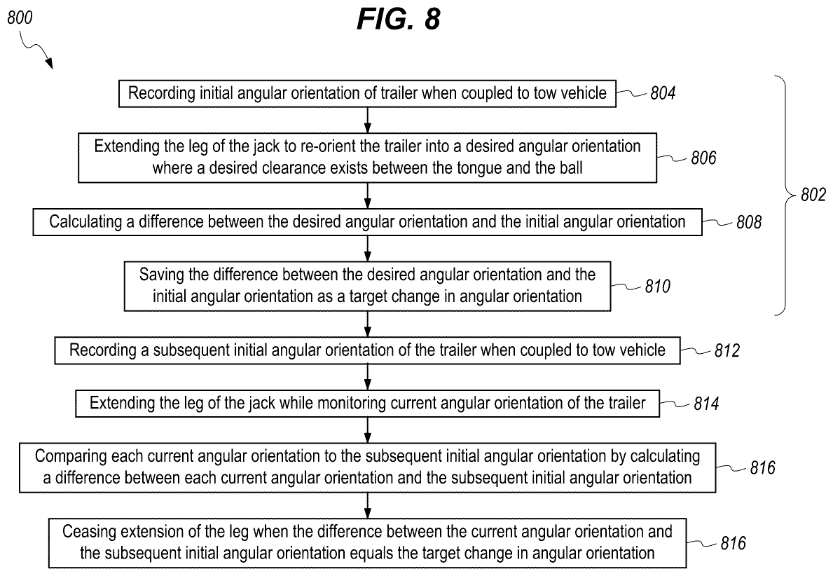

In even other embodiments, the control system 200 may perform uncoupling routines/algorithms that reorient the trailer 100 using just data from the sensor 306. For example, FIG. 8 depicts a method 800 of uncoupling the trailer 100 from the tow vehicle 102 using just sensor data and controlling the motor 300 to achieve a target change D in angular orientation of the trailer 100. The method 800 may include a first step 802 which includes training the control system 200 set or establish the target change D in angular orientation and then, once the step 802 of training the control system 200 has been conducted and the target change D in angular orientation has been saved/recorded, the subsequent steps of the method 800 may be performed using the already known target change D in angular orientation, without retraining (i.e., without performing the training step 802 over and over). The training step 802 may include a step 804 of recording an initial angular orientation of the trailer 100 when coupled to the tow vehicle 102, a step 806 of extending the leg 204 of the jack 118 to re-orient the trailer 100 into a desired angular orientation where a desired/suitable/target clearance exists (is established) between the tongue 112 and the ball 106, a step 808 of calculating a difference between the desired angular orientation and the initial angulation orientation, and a step 810 of saving the difference between the desired angular orientation and the initial angular orientation as a target change D in angular orientation of the trailer 100. Thereafter, on subsequent performances/operations of the method 800, the training step 802 may be skipped and the method 800 may proceed and begin at step 812, which includes recording a subsequent initial angular orientation of the trailer 100 when the trailer 100 is coupled to the tow vehicle 102. Then, at step 814, the method 800 includes extending the leg 204 of the jack while continuously monitoring a current angular orientation of the trailer 100 and, at step 816, comparing each current angular orientation of the trailer 100 to the subsequent initial angular orientation by calculating a difference between each current angular orientation and the subsequent initial angular orientation. Then, at step 818, the method 800 may include ceasing/stopping extension of the leg 204 when the difference between the current angular orientation and the subsequent initial angular orientation equals the target change in angular orientation. Thus, the method 800 can be utilized to orient the trailer 100 in the desired angular orientation based on a target change in orientation, which will allow for automatic orientation of the trailer 100 for uncoupling regardless of whether the ground surface G is horizontal or sloped.

With this method 800, the training steps 802 may be performed or undertaken the first time that the method 800 is performed; and then, during later performances of the method 800, the training steps 802 may be skipped (because the target change D in angular orientation has already been learned during the prior training steps 802), and the method 800 may commence with step 812 for each subsequent performance of the method 800. Thus, steps 812-812 of the method 800 may collectively referred to as the subsequent steps 818 and, after a first performance of the training steps 802, subsequent performances of the method 800 may simply involve execution of the subsequent steps 818.

In embodiments, control system 200 may implement/execute the method 800. For example, the controller 302 may be configured to instruct the motor 300 to extend the leg 204 and thereby orient the trailer 100 into a desired angular orientation where there is sufficient clearance (e.g., clearance C2) using sensor data that is indicative of the orientation/attitude of the trailer 100, rather than using motor characteristics (e.g., current and/or voltage) and/or time periods as detailed above. In this example, the control system 200 may be configured to activate the motor 300 and thereby extend the leg 204 until the target change D in angular orientation is obtained, as determined by the controller 302. The target change D in angular orientation may be set/programmed into the control system 200 at the factory and/or the user may train the control system 200, as described herein, to learn the target change D in angular orientation. To train the control system 200 to learn the target change D in angular orientation, the user may first save/record an initial angular orientation of the trailer 100 when coupled to the tow vehicle 102 in the control system 200. For example, when the trailer 100 is coupled to the tow vehicle 102 as shown in FIG. 7A, the user may interact with the user interface 212 to save/record the angular orientation A1 as an initial angular orientation. Second, the user may interact with the user interface 212 to manually extend the leg 204 and re-orient the trailer 100 into a desired orientation where there is sufficient clearance between the tongue 112 and the ball 106, such as the angular orientation A3 in FIG. 7C, and then the user may interact with the user interface 212 to save/record the angular orientation A3 as a desired angular orientation in the control system 200. After saving the desired orientation in the control system 200, the controller 302 may calculate a difference between the desired angular orientation and the initial angulation orientation and record the difference between the desired angular orientation and the initial angulation orientation as a target change D in angular orientation. When the control system 200 is thereafter utilized to uncouple the trailer 100 from the tow vehicle 102, controller 302 can first detect and record a subsequent initial angular orientation of trailer 100 when coupled to the tow vehicle 102, and then instruct the motor 300 to extend the leg 204. While the motor 300 is extending the leg 204, the controller 302 is configured to continuously monitor the current angular orientation of the trailer 100 and compare each current angular orientation of the trailer 100 to the subsequent initial angular orientation by calculating a difference between each current angular orientation and the subsequent initial angular orientation. When the difference between the current angular orientation and the subsequent initial angular orientation equals the target change D in angular orientation, the controller 302 is configured to instruct the motor 300 to cease extension of the leg 204. Thus, the controller 302 can be configured to orient the trailer 100 in the desired angular orientation based on a target change in orientation, which will allow the uncoupling routine/algorithm to be utilized regardless of whether the ground surface G is horizontal or sloped.

In embodiments, after the controller 302 performs the method 800, the user may desire to make manual adjustments to the extension of the leg 204 by controlling the motor 300 at the user interface 112. These manual adjustments to the position of the leg 204 will result in raising or lowering the front end 702 of the trailer 100 so as to position the trailer 100 in a preferred angular orientation that provides safe amount of clearance for removal of the tow vehicle 102. When the user makes these manual adjustments, the controller 302 may automictically save these adjustments and use the adjustments to update what will be used as the desired angular orientation when calculating the target change in angular orientation. In this manner, the control system 200 may learn how to modify the target change in angular orientation to make the algorithm progressively better during future uses.

As discussed above, the jack control system 200 may be integrated into and utilized with various types of trailers 100, such as the travel trailer depicted in FIG. 1. FIGS. 9A-9F depict an example where the jack control system 200 is utilized with a fifth wheel trailer 900, according to one or more embodiments. Thus, FIGS. 9A-9F depict an embodiment where the trailer 100 is a fifth wheel trailer 900.

FIG. 9A depicts the fifth wheel trailer 900 (hereinafter, the trailer 900) when separated/detached from a tow vehicle 902 and FIG. 9B depicts the trailer 900 when attached to the tow vehicle 902, according to embodiments. As shown in FIG. 9A, the trailer 900 includes a front end 904 and a rear end 906 opposite the front end 904. Moreover, because the trailer 900 is configured as a fifth wheel trailer, the trailer 900 includes base 908 at which the wheels 910 are mounted, and the trailer 900 further includes an upper deck 912 arranged on top of the base 908. As shown, the upper deck 912 extends to the front end 904, beyond a front 914 of the base 908, such that the portion of the upper deck 912 at the front end 904 defines a shelf or overhang 916 that may be positioned over (a portion of) the tow vehicle 902 when connecting the trailer 900 to the tow vehicle 902. Further, FIG. 9A depicts a goose neck 920 extending from the upper deck 912 and a king pin 922 extending from the goose neck 920. As shown in FIG. 9B, a hitch 930 is provided on the tow vehicle 902, for example, in a bed 932 of the tow vehicle 902 when configured as a pick up truck. The hitch 930 is configured to receive (and lock onto) the king pin 922 to thereby connect the trailer 900 to the tow vehicle 902.

FIG. 9B depicts the goose neck 920 extending over the hitch 930 with the king pin 922 extending into and engaged with the hitch 930. The hitch 930 includes a locking mechanism that is operable to selectively lock/trap the king pin 922 within an opening (obscured from view) of the hitch 930. For example, the locking mechanism may include a jaw that is operable to engage and retain the king pin 922 when in a locked position. A hitch latch 934 may be provided that is operably coupled to the locking mechanism (i.e., the hitch latch 934 may be operatively coupled to the jaw), wherein the hitch latch 934 may be moved between the locked and unlocked position to thereby lock and unlock, respectively, the locking mechanism of the hitch 930. When the hitch latch 934 is in the unlocked position, the kingpin 922 may be inserted into and removed from the opening in the jaw of the hitch 930; whereas, when the king pin 922 is arranged in the opening of the jaw of the hitch 930, the hitch latch 934 may be moved into the locked position to thereby lock the locking mechanism and thereby trap/retain the king pin 922 within the jaw of the hitch 930. FIG. 9B depicts the hitch 930 when the hitch latch 934 has been moved into the locked position to thereby engage the locking mechanism and lock the king pin 922 within the hitch 930. In the illustrated embodiment, a pin 936 is provided that extends through the hitch latch 934 and couples/connects the hitch latch 934 to a body 938 of the hitch 930. When the pin 936 is inserted through the hitch latch 934 and the body 938, the pin 936 is locked to the body 938 such that it cannot be moved into the unlocked position, such that the pin 936 is operable to lock the hitch latch 934 in the locked position, as shown in FIG. 9B. Thus, upon removal of the pin 936, the hitch latch 934 may be moved into the unlocked position.

Referring again to FIG. 9A, the trailer 900 includes a pair of legs 940 (i.e., landing gear) that may be extended or retracted. The trailer 900 includes a motor (not shown) operatively connected to the legs 940 to thereby cause extension or retraction of the legs 940. More specifically, the motor may be actuated to extend the legs 940 toward the ground, such that the legs 940 may make contact with the ground and thereby support the trailer 900 in a suitable orientation to allow for the tow vehicle 902 to be disconnected from the trailer 900 and removed therefrom, as shown in FIG. 9A. Further, after connecting the trailer 900 to the tow vehicle 902 as detailed above, the motor may be actuated to retract/withdrawal the legs 940 (upward toward the base 908), such that the legs 940 are lifted up off of the ground and such that the weight of the trailer 900 has been offloaded from the legs 940 and transferred to the tow vehicle 902. Thus, the legs 940 may be referred to as motorized landing gear that may be extended downward towards the ground or upward (e.g., toward the base 908).

Referring to FIG. 9D, the user interface 214 is depicted when integrated into and with the trailer 900, according to one or more embodiments. The user interface 214 in the illustrated embodiment may be similarly configured and operatable, as detailed above with reference to the trailer 100; however, in the illustrated embodiment, the user interface 214 may be installed/mounted inside of the trailer 900 or on an outside surface of the trailer 900, as opposed to being integrated into a tongue jack, such as the jack 118 shown in FIGS. 1-2. Similar to the embodiments shown in FIGS. 1-2 where the user interface 214 is contained and protected by the housing 202, FIG. 9D depicts an embodiment where the user interface 214 is contained within a housing 942 and the housing 942 may further include a lid 944, wherein the lid 944 may be moved between open and closed positions. The lid 944 covers and protects the user interface 214 when in the closed position, and the user interface 214 is uncovered and accessible to the end user when the lid 944 is in the open position, as shown in FIG. 9D.

FIG. 9E depicts some example functionality of the user interface 214 and how it may be utilized to implement one or more uncoupling sequences/routines, according to one or more embodiments. As shown, the user interface 214 includes a power button, that the user may press to turn the system 200 and/or the user interface 214 on or off. The user interface 214 includes a display 948 that is configured to display different parameters of the system 200 and is configured to allow the user to control aspects of the system 200. Further, FIG. 9E depicts a home screen 949, according to one or more embodiments. Here, the display 948 is a touch screen display that, when turned on by pressing the power button 946, displays the home screen 949 that includes an “AUTO UNHOOK” option (or button) 950 and an “AUTO RECONNECT” option (or button) 952. The “AUTO UNHOOK” option 950 may cause the system 200 to run/perform any one or more of the uncoupling sequences/routines detailed above. For example, (after the king pin 922 or tongue 112 have been unlocked from the hitch 930 or the ball 106 and) upon pressing the “AUTO UNHOOK” option 950, the motor may cause extension of the legs 920 until they hit and make contact with the ground and then continue to extending the legs 920 until the king pin 922 (or the tongue 112) has been raised sufficiently above the hitch 930 (or the ball 106) to allow the tow vehicle 902 (or the tow vehicle 102) to moved away from (and repositioned relative to) the trailer 900 (or the trailer 100) without the king pin 922 (or the tongue 112) getting caught/interfering with the hitch 930 (or the ball 106). As detailed above, the system 200 may ascertain grounding and/or unloading of the legs 920 via current, voltage, change in level/orientation, time, etc.; and the system 200 may continue extending the legs 920 as detailed above, for example, based on current, voltage, change in level/orientation, time, etc. Thus, the user may press the “AUTO UNHOOK” option 950 to cause the system 200 to perform any one or more of the methods/sequences/routines described above with reference to FIGS. 4-8.

Similarly, the user may select the “AUTO RECONNECT” option 952 to thereby cause the system 200 to run/perform a sequence/routine that effectively and automatically lowers the king pin 922 (or the tongue 112) onto the hitch 930 (or the ball 106), after the tow vehicle 902 (or the tow vehicle 102) has been moved back into proximity with the trailer 900 (or the trailer 100) such that the hitch 930 (or the ball 106) is directly beneath and aligned with the king pin 922 (or the tongue 112) to allow for reconnection there-between.

The user interface 214 may also be configured to run one or more other automatic sequences for controlling extension and/or retraction of the legs 920 (or the jack 118). In the illustrated embodiment, for example, the home screen 949 shows an AUTO LEVEL option (or button) 954 that may be run to level the trailer 900. Further, the user interface 214 may be configured to permit manual extension or retraction of the legs 920 (or the jack 118), for example, via actuation of a MANUAL option (or button) 956. For example, when the user selects the MANUAL option 956, another screen may be displayed with one or more buttons for causing extension and/or retraction of the legs 920 (or jack 118). Also, user interface 214 may also be configured to display one or more parameters of the system 200 and/or the trailer 900/100, such as the battery life via a battery indicator 958 and/or a current level/attitude of the trailer 900,100 via level/attitude orientation indicator 960, which are exemplified on the home screen 949 in FIG. 9E.

Upon pressing the AUTO UNHOOK” option (or button) 950, the system 200 may be configured to display an AUTO UNHOOK screen 962, which is exemplified in FIG. 9F. On the AUTO UNHOOK screen 962, the user may press a home button 964 to return to the home screen 949 shown in FIG. 9E. Also, the battery indicator 958 and the level/attitude orientation indicator 960 are present and displayed on the AUTO UNHOOK screen 962, in this example. Also in this example, the AUTO UNHOOK screen 962 includes a PROCEED option (or button) 964 that the user may select to initiate and start the algorithm/sequence/routine associated with the AUTO UNHOOK” option 950.

When the trailer 900 is coupled to the tow vehicle 902 as depicted in FIG. 9B, the following method or sequence may be performed to uncouple/detach the trailer 900 from the tow vehicle. Also when the trailer 900 is coupled to the tow vehicle 902, and as shown in FIG. 9B, hitch latch 934 is in the locked position and the pin 936 is installed in the hitch 930 and thereby preventing movement of the hitch latch 936 into the unlocked position. Thus, the pin 936 is first removed (i.e., removing the pin 936 from the hitch latch 934 and the body 938), and then the hitch latch 934 is moved into the unlocked position (i.e., moving the hitch latch 934 from the locked position to the unlocked position), as shown in FIG. 9C. Moving the hitch latch 934 into the unlocked position shown in FIG. 9C actuates the locking mechanism of the hitch 930 to thereby unlock the jaw of the locking mechanism, such that the king pin 922 is not longer engaged and locked in the jaw. Thus, moving the hitch latch 934 into the unlocked position opens the jaw of the locking mechanism. Then, the end user may access the user interface 214, for example, by opening the lid 944 to expose the user interface 214 as shown in FIG. 9D. As mentioned, the user interface 214 may pe provided on an exterior side of the trailer 900 or inside of the trailer 900 (or on the jack 118 of the trailer 100). Then the user may power on the user interface 214 and the system 200, for example, by pressing the power button 946, and then initiate/begin an automatic uncoupling routine/sequence/algorithm, for example, by pressing/selecting the AUTO UNHOOK option 950. Before the automatic uncoupling routine/sequence/algorithm starts/begins, however, the user may then confirm that they do indeed wish to start that automatic uncoupling routine/sequence/algorithm by selecting/pressing the PROCEED option 964, and this may provide the user with another chance to ensure that the king pin 922 (or the tongue 112) is unlocked from the hitch 930 (or the ball 106). After selecting PROCEED option 964, the system 200 executes the routine/sequence/algorithm, such that the PROCEED option 964 results in executing the routine/sequence/algorithm associated with the AUTO UNHOOK option 950 to thereby uncouple and sufficiently elevate/raise the trailer 900, 100 relative to the tow vehicle 902, 102. After uncoupling and raising the trailer 900, 100 relative to the tow vehicle 102, 902, the user may disconnect any electrical connections between the trailer 900, 100 and the tow vehicle 102, 902, and then the user may move the tow vehicle 902, 102 away from the trailer 900, 100. Thus, the method may include disconnecting electrical connections between the trailer 900, 100 and the tow vehicle 102, 902 and then moving the tow vehicle 902, 102 away from or relative to the trailer 900, 100.

It should be appreciated that, while FIGS. 9A-9F describe operation of the system 200, the user interface 214, and routines/sequences/algorithms with reference to a fifth wheel trailer 900, they may similarly be utilized with other types of trailers, such as the trailer 100 detailed above.

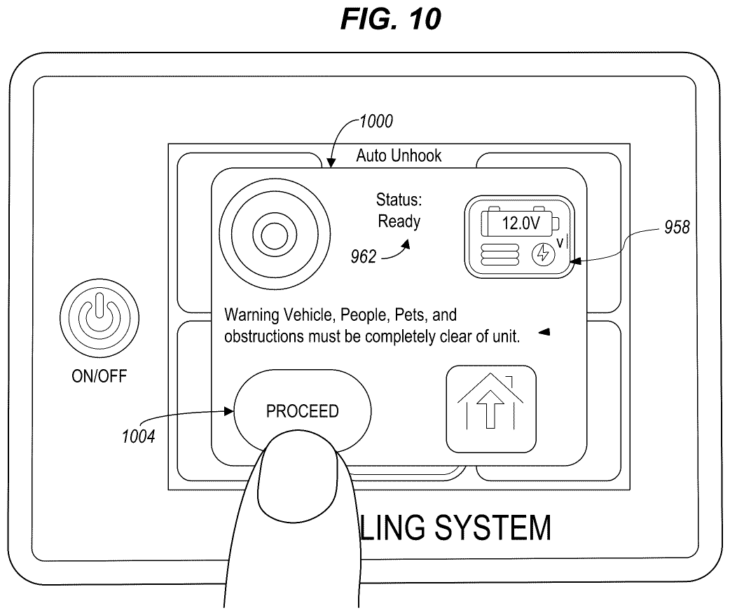

FIG. 10 depicts an example confirmation graphical user interface (GUI) 1000 that may be displayed on the user interface 214, according to one or more embodiments. The confirmation GUI 1000 may be displayed after the user selects the AUTO UNHOOK option 950 from the home screen 949, as described with reference to FIG. 9E. The confirmation GUI 1000 functions to provide the user with an opportunity to confirm that they wish to proceed with the automatic uncoupling routine before the system 200 begins executing the uncoupling algorithm. As shown in FIG. 10, the confirmation GUI 1000 includes a proceed confirmation button 1004 that the user may select to initiate and start the algorithm/sequence/routine associated with the AUTO UNHOOK option 950. The confirmation GUI 1000 may also display a warning message to alert the user to ensure that vehicles, people, pets, and obstructions are completely clear of the unit before proceeding. The confirmation GUI 1000 may further include a battery indicator 958 that displays the current battery level of the system 200, such as 12.0V as shown in the illustrated embodiment. The confirmation GUI 1000 may also include a status indicator 962 that displays the current status of the system 200, such as “Status: Ready” to indicate that the system 200 is ready to execute the uncoupling routine. Upon selecting the proceed confirmation button 1004, the system 200 executes the routine/sequence/algorithm to thereby uncouple and sufficiently elevate/raise the trailer 900, 100 relative to the tow vehicle 902, 102, as described above with reference to FIGS. 4-8.

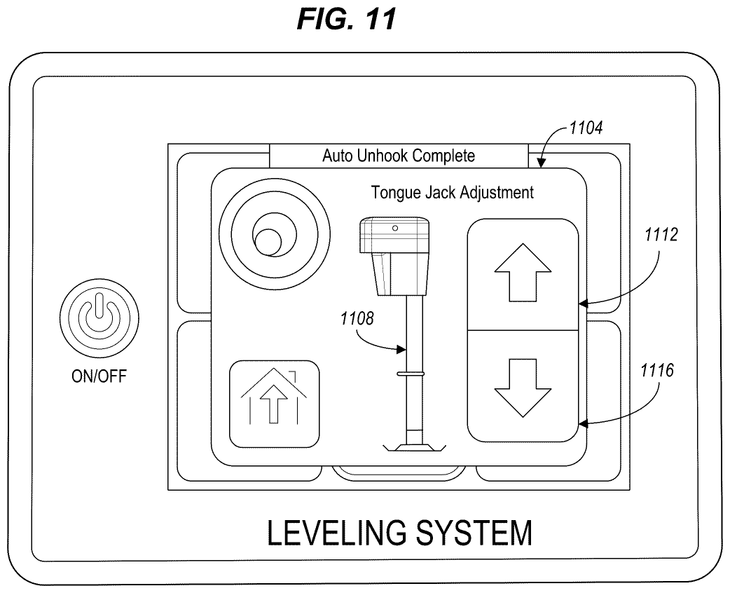

FIG. 11 depicts a jack adjust GUI 1104. After the automatic uncoupling routine has been completed, the user interface 214 may display a jack adjustment GUI 1104, as shown in FIG. 11. The jack adjustment GUI 1104 functions to permit the user to make manual adjustments to the position of the leg 204 or legs 940. The jack adjustment GUI 1104 may include a jack state indicator 1108 that visually represents the current state or position of the jack 118 or legs 940. The jack adjustment GUI 1104 may further include an extension button 1112 that the user may press to cause further extension of the leg 204 or legs 940, and a retraction button 1116 that the user may press to cause retraction of the leg 204 or legs 940. These manual adjustment buttons 1112, 1116 allow the user to fine-tune the position of the trailer 100, 900 relative to the tow vehicle 102, 902 to ensure that there is adequate clearance between the tongue 112 and the ball 106 (or between the king pin 922 and the hitch 930) to permit safe removal of the tow vehicle 102, 902. As described above, when the user makes these manual adjustments, the controller 302 may automatically save these adjustments and use the adjustments to update the stored uncoupling routine, such that the control system 200 automatically learns how to modify its uncoupling routine to ensure suitable clearance during future uses. The jack adjustment GUI 1104 may also display a message indicating that the auto unhook process is complete, such as “Auto Unhook Complete” as shown in the illustrated embodiment. The jack adjustment GUI 1104 may further include a return to home button that allows the user to navigate back to the home screen 949.

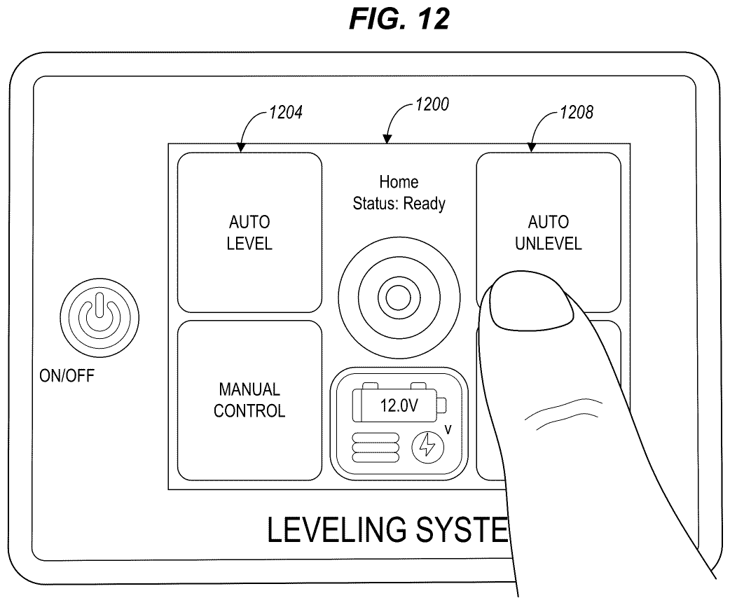

Additionally, the user interface 214 may be configured to display an auto level GUI 1200, as shown in FIG. 12. The auto level GUI 1200 may be displayed when the user selects the AUTO LEVEL option 954 from the home screen 949. The auto level GUI 1200 includes an auto level button 1204 that the user may select to initiate an automatic leveling routine that levels the trailer 100, 900. The auto level GUI 1200 may also include an auto unlevel button 1208 that the user may select to reverse the leveling process. The auto level GUI 1200 may further include the battery indicator 958 and the level/attitude orientation indicator 960 to provide the user with information about the current battery level and the current orientation of the trailer 100, 900. The auto level GUI 1200 may also include a manual control option 956 that allows the user to manually control the extension and retraction of the jack 118 or legs 940. As described above with reference to FIG. 9E, when using the auto level function after the auto unhook function, the front to rear angle of the unit may be detected and recorded to be used for the auto reconnect function, such that the system 200 can automatically lower the trailer 100, 900 back onto the tow vehicle 102, 902 when the AUTO RECONNECT option 952 is selected.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A jack system, comprising:
a jack including:
a motor, and
a leg operatively connected to the motor, wherein the motor is operable to extend or retract the leg; and
a controller operatively connected to the motor, wherein the controller is configured to:
monitor electrical current draw of the motor as the motor extends the leg and determine a grounded state when electrical current draw exceeds a minimum threshold;
upon determination of the grounded state, instruct the motor to continue extending the leg, continue monitoring electrical current draw of the motor as the motor continues to extend the leg, and determine a currently loading state as the electrical current draw increases over time;
determine a fully loaded state when electrical current draw stabilizes; and
instruct the motor to continue extending the leg for a predetermined period of time.

2. The jack system of claim 1, wherein the predetermined period of time is five seconds.

3. The jack system of claim 1, further comprising a level sensor configured to transmit a level feedback signal to the controller, and wherein the controller is further configured to detect and record the level feedback signal.

4. The jack system of claim 3, wherein the controller is configured to:
detect and record the level feedback signal as an initial angular orientation before detection of the grounded state;
detect and record a target angular orientation after the predetermined period of time; and
calculate a target change in orientation a difference between the target angular orientation and the initial angular orientation.

5. The jack system of claim 4, wherein the controller is further configured:
to detect and record the level feedback signal received before the grounded state as a current initial angular orientation;
to detect and record the level feedback signal received after the predetermined period of time as a current angular orientation; and
instruct the motor to continue extending the leg after the predetermined period of time if, after the predetermined period of time, the controller determines that a difference between the current angular orientation and the current initial angular orientation is not equal to the target angular orientation.

6. The jack system of claim 1, further comprising a user interface operable to control the motor.

7. The jack system of claim 6, wherein the user interface comprises a touch screen display.

8. The jack system of claim 7, wherein touch screen display is configured to a display manual extension button and/or manual retraction button after the predetermined period of time.

9. A jack system, comprising:
a jack including:
a motor, and
a leg operatively connected to the motor, wherein the motor is operable to extend or retract the leg; and
a controller operatively connected to the motor, wherein the controller is configured to:
monitor electrical current draw of the motor and determine a grounded state when electrical current draw exceeds a minimum threshold; and
instruct the motor to continue extending the leg for a predetermined period of time.

10. The jack system of claim 9, wherein, before instructing the motor to continue extending the leg for the predetermined period of time, the controller is further configured to:
upon determination of the grounded state, instruct the motor to continue extending the leg, continue monitoring electrical current draw of the motor as the motor continues to extend the leg, and determine a currently loading state as the electrical current draw increases over time; and
determine a fully loaded state when the electrical current draw stabilizes over time.

11. The jack system of claim 9, further comprising a level sensor configured to provide readings indicative of angular orientation.

12. The jack system of claim 11, wherein the controller is configured to:
record an initial angular orientation based on the readings received from the level sensor,
compare current angular orientation readings from the level sensor to the initial angular orientation, and
instruct the motor to cease extension of the leg when a difference between the initial angular orientation and the current angular orientation reading from the level sensor equals a target change in angular orientation.

13. The jack system of claim 12, wherein the level sensor is a multi-axis digital sensor.

14. The jack system of claim 12, wherein the target change in angular orientation is 0.5 degrees.

15. The jack system of claim 14, further comprising a user interface operable to cause recordation of the initial angular orientation and extension of the leg upon activation of the user interface.

16. A jack system, comprising:
a jack including:
a motor, and
a leg operatively connected to the motor, wherein the motor is operable to extend or retract the leg;
a level sensor configured to provide readings indicative of angular orientation; and
a controller operatively connected to the motor and the level sensor, wherein the controller is configured to:
record a preliminary angular orientation based on the readings received from the level sensor;
monitor electrical current draw of the motor as the motor extends the leg and determine a grounded state of the leg when electrical current draw exceeds a minimum threshold;
upon determination of the grounded state, instruct the motor to continue extending the leg, continue monitoring electrical current draw of the motor as the motor continues to extend the leg, and determine a currently loading state as the electrical current draw increases over time;
determine a fully loaded state when the electrical current draw stabilizes over time;
instruct the motor to continue extending the leg for a predetermined period of time;
instruct the motor to extend the leg and compare current readings from the level sensor to the preliminary angular orientation; and
instruct the motor to cease extension of the leg when a difference between the preliminary angular orientation and the current reading from the level sensor equals a target change in angular orientation.

17. The jack system of claim 16, wherein the level sensor is a multi-axis digital sensor.

18. The jack system of claim 17, further comprising a user interface operable to control the motor.

19. The jack system of claim 18, wherein the user interface comprises a touch screen display.

20. The jack system of claim 19, wherein touch screen display is configured to a display manual extension button and/or manual retraction button after the predetermined period of time.
